(19) United States
(12) Patent Application Publication
(10) Pub. No.: US 2016/0149817 A1
(43) Pub. Date: May 26, 2016

(54) ANALYSIS DEVICE

(71) Applicant: Hitachi, Ltd., Tokyo (JP)

(72) Inventors: Naoki TANIDA, Tokyo (JP); Takashi ISOBE, Tokyo (JP); Tetsuya OOHASHI, Tokyo (JP)

(21) Appl. No.: 14/887,805

(22) Filed: Oct. 20, 2015

(30) Foreign Application Priority Data
Nov. 20, 2014 (JP) 2014-235749

(51) Int. Cl. H04L 12/801; H04L 29/06; H04L 12/26

(52) U.S. Cl. CPC H04L 47/193; H04L 43/062; H04L 69/22

(57) ABSTRACT

An analysis device analyzes a packet processed by a communication device connected with a network. The analysis device includes a receiver and an analyzer. The receiver receives a mirror packet of the packet transmitted through the network. The analyzer obtains and analyzes a portion of information in the mirror packet, and determines a necessity or lack thereof for a function of the communication device to be performed on the packet transmitted through the network based on analysis results of the analyzer.

### CLAIM OF PRIORITY

The present application claims priority from Japanese patent application JP2014-235749 filed on Nov. 20, 2014, the content of which is hereby incorporated by reference into this application.

### BACKGROUND

The present invention pertains to controlling a communication device. Due to increasing speed of network lines and increasing diversification and capacity of communication devices, there is an increasing need for network appliances to handle multiple sessions. The number of sessions that a network appliance can process is limited, and thus, in order for the network appliance to function effectively in a network in which the number of sessions has exceeded what can be processed, it is necessary to provide multiple network appliances.

JP 2012-142862 A is a disclosure of the background art of the present technical field. JP 2012-142862 A discloses “a communication device that processes TCP/IP communication having: a software communication means that processes TCP/IP communication by TCP/IP control by software; a hardware communication means that processes TCP/IP communication by TCP/IP control by a TOE; a communication load managing means that manages communication load information that dynamically changes according to the communication load; and a communication process allocation means that allocates the TCP/IP communication processes to the software communication means or the hardware communication means, the communication process allocation means allocating the TCP/IP communication process to the hardware communication means if the communication load information is at or above a prescribed threshold” (abstract).

### SUMMARY

In the method disclosed in JP 2012-142862 A, if the communication load information is at or above a prescribed threshold, the TCP/IP communication process is allocated to the hardware communication means. However, if there are many sessions to be processed, then there is a possibility that the number of sessions that can be processed by both the software communication means and the hardware communication means would be exceeded.

Thus, a technique that causes the communication device to function effectively in a network with many sessions is desired. The inventors of the present invention have analyzed data transmitted over a network and have found that even if specific functions provided by the communication device were used, there are pieces of data that are not highly affected by such functions.

A representative example of the present invention is an analysis device analyzes a packet processed by a communication device connected with a network. The analysis device includes a receiver and an analyzer.

The receiver receives a mirror packet of the packet transmitted through the network. The analyzer obtains and analyzes a portion of information in the mirror packet, and determines a necessity or lack thereof for a function of the communication device to be performed on the packet transmitted through the network based on analysis results of the analyzer.

According to an aspect of the present invention, it is possible to cause a communication device to function effectively in a network with many communication instances.

Problems, configurations, and effects other than those described above are clarified by the following detailed description of embodiments.

### BRIEF DESCRIPTION OF DRAWINGS

FIG. 1 is a configurational drawing of a network system including a multiple session analysis device 100 in Embodiment 1;

FIG. 2 shows a hardware configuration example of the multiple session analysis device in Embodiment 1;

FIG. 3 shows a TCP packet format;

FIG. 4 shows a block configuration example of functions of a network system including a multiple session analysis device in Embodiment 1;

FIG. 5 shows details of a block function configuration example of the multiple session analysis device in Embodiment 1;

FIG. 6 shows an example of data structure in a communication information storing unit in Embodiment 1;

FIG. 7 shows an example of data structure in the communication information storing unit in Embodiment 1;

FIG. 8 shows an example of data structure in the communication information storing unit in Embodiment 1;

FIG. 9 shows an example of data structure in the communication information storing unit in Embodiment 1;

FIG. 10 shows an example of data structure in the communication information storing unit in Embodiment 1;

FIG. 11 is a flow chart showing operation details of the reception processing unit in Embodiment 1;

FIG. 12 is a flow chart showing operation details of a communication information cycle processing unit in Embodiment 1;

FIG. 13 is a flow chart showing an operation performed by the communication information cycle processing unit of calculating the necessity score for the WAN acceleration function of the communication device in Embodiment 1;

FIG. 14 is a configurational example of a network system including a computer where a virtual multiple session analysis device is implemented in Embodiment 2;

FIG. 15 shows a hardware configuration drawing of the computer where the virtual multiple session analysis device is implemented in Embodiment 2;

FIG. 16 shows a function block configuration example of the computer where the virtual multiple session analysis device is implemented in Embodiment 2;

FIG. 17 is a configurational example of a network system including a communication device including a multiple session analysis unit in Embodiment 3;

FIG. 18 shows a hardware configuration drawing of the communication device including the multiple session analysis unit in Embodiment 3;

FIG. 19 shows a function block configuration example of the communication device including the multiple session analysis unit in Embodiment 3;

FIG. 20 shows a function block configuration example of a system including a multiple session analysis device in Embodiment 4;

FIG. 21 is a flow chart showing operations of a communication information cycle processing unit in Embodiment 4;

FIG. 22 is a flow chart showing an operation by the communication information cycle processing unit of calculating the necessity score for the firewall function of the communication device in Embodiment 4;

FIG. 23 shows a configuration of a network system including a multiple session analysis device in Embodiment 5;

FIG. 24 shows a hardware configuration example of the multiple session analysis device in Embodiment 5;

FIG. 25 shows a function block configuration example of a system including a multiple session analysis device in Embodiment 5;

FIG. 26 shows an example of data structure in the communication information storing unit in Embodiment 5; and

FIG. 27 is a flow chart showing an operation performed by the communication information cycle processing unit of calculating the necessity score for the WAN acceleration function of the communication device in Embodiment 6.

### DETAILED DESCRIPTION OF EMBODIMENTS

Hereinafter, an embodiment of this invention is described with reference to the accompanying drawings. It should be noted that this embodiment is merely an example to realize this invention and is not to limit the technical scope of this invention. Elements common to the drawings are denoted by the same reference signs.

Below, a packet analysis method for controlling the functions of a communication device will be described. In the packet analysis method, a mirror packet of a packet transmitted over a network is received and it is determined whether or not functions of the communication device need to be performed on transmitted data on the basis of some information obtained from the mirror packet.

By selecting packets on which the communication device function is performed, it is possible to prioritize application (execution) of the communication device functions to packets for which execution of communication device functions would be effective. In this manner, it is possible for the functions of the communication device to be operated effectively on a network in which many packets are transmitted.

In the present disclosure, one communication instance is defined by a start packet and an end packet. The packets constituting one communication instance are all packets from the start packet to the end packet. One communication instance is a session in a communication protocol, for example.

In the TCP/IP protocol, one communication instance is constituted of one or more sessions, for example. A TCP session is defined by source and destination IP addresses and port numbers, and the start and end of one session is defined by a SYN packet and FIN packet. In the UDP/IP protocol, a session is defined by source and destination IP addresses and port numbers, and is constituted of consecutive packets within a prescribed time period elapsed from the previous packet, for example.

### Embodiment 1

Embodiment 1 describes one basic example. In the present embodiment, a configuration example is shown in which the functions of a communication device are effectively used in a network having a greater number of sessions than can be handled by the communication device.

Below, a WAN accelerator is described as an example of a communication device. WAN accelerators are network appliances. Network appliances are devices having specific functions for performing specific processes on packets on a network, and are either physical or virtual devices. A plurality of virtual network appliances can operate on a single physical device. There are no special limitations on the hardware configuration and software configuration of network appliances.

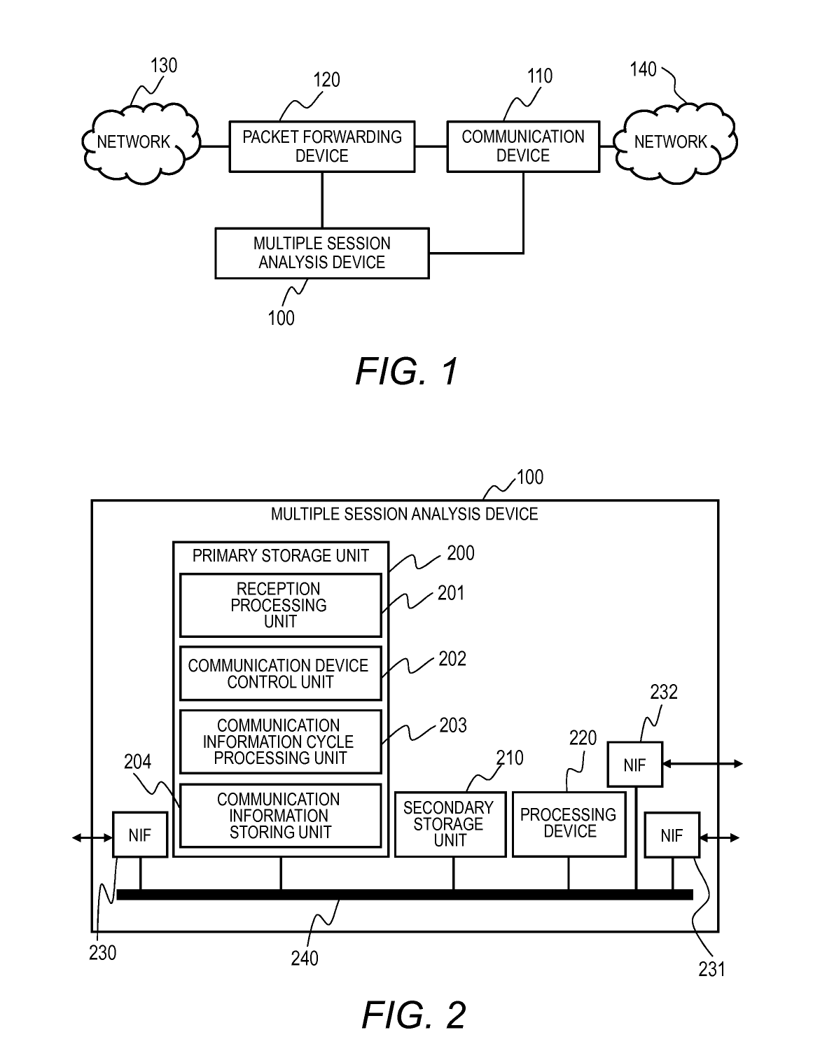

FIG. 1 is a configurational drawing of a network system including a multiple session analysis device 100 of the present embodiment. The multiple session analysis device 100 is connected to a communication device 110 and a packet forwarding device 120. The communication device 110 is connected to a network 140 and the packet forwarding device 120 is connected to a network 130.

The multiple session analysis device 100 receives from the packet forwarding device 120 a mirror packet of a packet being transmitted between the communication device 110 and the packet forwarding device 120. The multiple session analysis device 100 uses the mirror packet to manage packets to be processed by the communication device 110 for each session.

The multiple session analysis device 100 determines whether or not special functions of the communication device 110 need to be performed according to the information managed for each session. The multiple session analysis device 100 controls the communication device 110 such that functions of the communication device 110 are active in each session where it was determined that it is necessary to perform the functions of the communication device 110. In the example described below, the session is a TCP session. By managing and controlling the communication device 110 for each TCP session, it is possible to control the functions of the communication device efficiently and effectively.

The multiple session analysis device 100 controls the communication device 110 such that functions of the communication device 110 are inactive in each session where it was determined that it is not necessary to perform the functions of the communication device 110. In this manner, the communication device 110 need only manage sessions for which functions thereof are active, and simply relay as is packets belonging to sessions for which functions thereof are inactive.

By selecting sessions for which the communication device function is to be performed, it is possible to prioritize execution of the communication device functions for sessions for which execution of communication device functions would be effective. In this manner, it is possible to effectively use the functions of the communication device 110 in a network having a greater number of sessions than the maximum that can be handled by the communication device 110. Because there is no need to install multiple communication devices on the network, it is possible to realize low cost and appropriate packet control in a network in which there are many sessions.

Below, for ease of understanding, packets flowing from the network 130 to the network 140 are referred to as right-direction packets, and packets flowing from the network 140 to the network 130 are referred to as left-direction packets. Also, computers transmitting packets in the right-direction are referred to as left-side computers and computers transmitted packets in the left-direction are referred to as right-side computers.

FIG. 2 shows a hardware configuration example of the multiple session analysis device 100 of the present embodiment. The multiple session analysis device 100 includes a primary storage unit 200, a secondary storage unit 210, a processing device 220, a network interface 230 (NIF), a NIF 231, a NIF 232, and a system bus 240 that connects all of these to each other and transmits data.

The primary storage unit 200 temporarily stores programs and data and handles reading and writing of data. The secondary storage unit 210 stores programs and data on a long-term basis, and the stored programs and data are loaded to the primary storage unit 230 as necessary. The processing device 220 executes programs on the primary storage unit 200, processes data on the primary storage unit 200, and writes the results to the primary storage unit 200.

The primary storage unit 200 stores programs such as a reception processing unit 201, a communication device control unit 202, a communication information cycle processing unit 203, and a communication information storing unit 204. The reception processing unit 201 processes information in mirror packets received from the packet forwarding device 120 and data in the communication information storing unit 204, and stores the results thereof in the communication information storing unit 204.

The communication information cycle processing unit 203 is an analysis unit that analyzes data in the communication information storing unit 204 and stores the analysis results in the communication information storing unit 204. The communication device control unit 202 processes data in the communication information storing unit 204, controls the functions of the communication device 110 for each session, and stores the results in the communication information storing unit 204. The communication information storing unit 204 reads and writes data in accordance with the reception processing unit 201, the communication device control unit 202, and the communication information cycle processing unit 203.

The processing device 220 functions as the respective functional units by operating according to the programs in the primary storage unit 200. The programs can be installed on the multiple session analysis device 100 by a program distribution server or a computer-readable non-transitory storage medium, and can be stored in the secondary storage unit 210. This similarly applies to other devices.

By the configuration above, packets passing between the network 130 and the network 140 through the packet forwarding device 120 and the communication device 110 are mirrored by the packet forwarding device 120. The information of the packets passing through the communication device 110 is processed by the reception processing unit 201.

The communication information cycle processing unit 203 obtains a portion of the information of the packets from the communication information storing unit 204 and determines for each session whether to activate or deactivate functions of the communication device 110. The communication device control unit 202 controls the functions of the communication device 110 for each session.

FIG. 2 shows an example of the primary storage unit 200, the secondary storage unit 210, the processing device 220, the NIF 230, the NIF 231, and the NIF 232 being connected through one system bus 240. Other configurations may be adopted in which these are connected through a plurality of system buses or directly connected to each other without the use of a system bus. The number of processing devices, primary storage units, secondary storage units, and NIFs may differ from what is shown.

FIG. 2 shows an example in which the reception processing unit 201, the communication device control unit 202, the communication information cycle processing unit 203, and the communication information storing unit 204 are all configured from software. Some or all of these functions may be installed in one or more of the processing device 200, the NIF 230, the NIF 231, or the NIF 232. The NIF 230, the NIF 231, and the NIF 232 may be logical NIFs installed on one physical NIF.

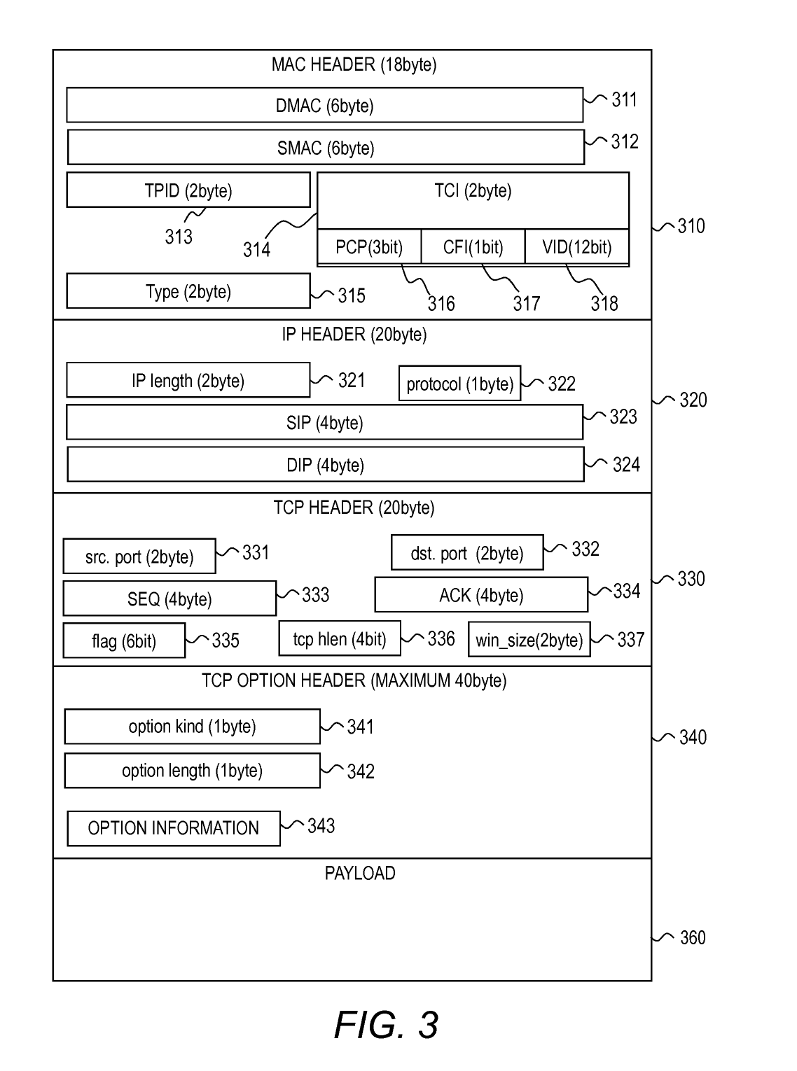

FIG. 3 shows the format of a mirror packet received by the multiple session analysis device 100. Each packet includes a MAC header 310, an IP header 320, a TCP header 330, a TCP option header 340, and a payload 360.

The MAC header 310 includes a DMAC 311 indicating the destination

MAC address, an SMAC 312 indicating the source MAC address, a TPID 313 indicating that the frame has a tag and the type of tag, a TCI 314 indicating tag information, and a type 315 indicating the MAC frame type. The TCI 314 includes a PCP 316 indicating priority, a CFI 317 indicating whether the MAC address is in standard format, and a VID 318 indicating the ID of a VLAN.

In networks that do not use a VLAN, the TPID 313 and the TCI 314 are absent. In such a case, the multiple session analysis device 100 processes the packet with the VID being 0.

The IP header 320 includes an IP length 321 indicating the length of the packet excluding the MAC header 310, a protocol 322 indicating the protocol number, an SIP 323 indicating the source IP address, and a DIP 324 indicating the destination IP address.

The TCP header 330 includes an src.port 331 indicating the source port number, a dst.port 332 indicating the destination port number, an SEQ 333 indicating the transmission sequence number, an ACK 334 indicating the reception sequence number, a flag 335 indicating the TCP flag number, a tcp hlen 336 indicating the length of the TCP header, and a win_size 337 that notifies the opposing device of the advertised window size.

The TCP option header 340 includes 0 to multiple options. In this example, the TCP option header 340 includes an option kind 341 indicating the option type, an option length 342 indicating the length of the option, and option information 343 indicating information according to the option type.

The maximum segment size (MSS) option is used in order to notify the opposing device of the maximum segment size that can be received by the subject device when starting TCP communication. The selective acknowledgment (SACK) option is used in order for one device to notify the opposing device that the one device can handle the SACK option when starting TCP communication. The SACK option is additionally used in order to notify the opposing device that part of the packet was received when it is detected that an interruption has occurred in the middle of communication.

The time stamp option is used in order to notify the opposing device of the time at which the subject device has received the signal during communication. The window scale option is used in order to increase the maximum advertised window size that can be outputted to the opposing device by notifying the opposing device of the bit size obtained by f-shifting the value to be outputted as the win_size 337. In this manner, the TCP option is used in order to indicate to the opposing device the time at which communication has started, and functions and information that the subject device can handle during communication.

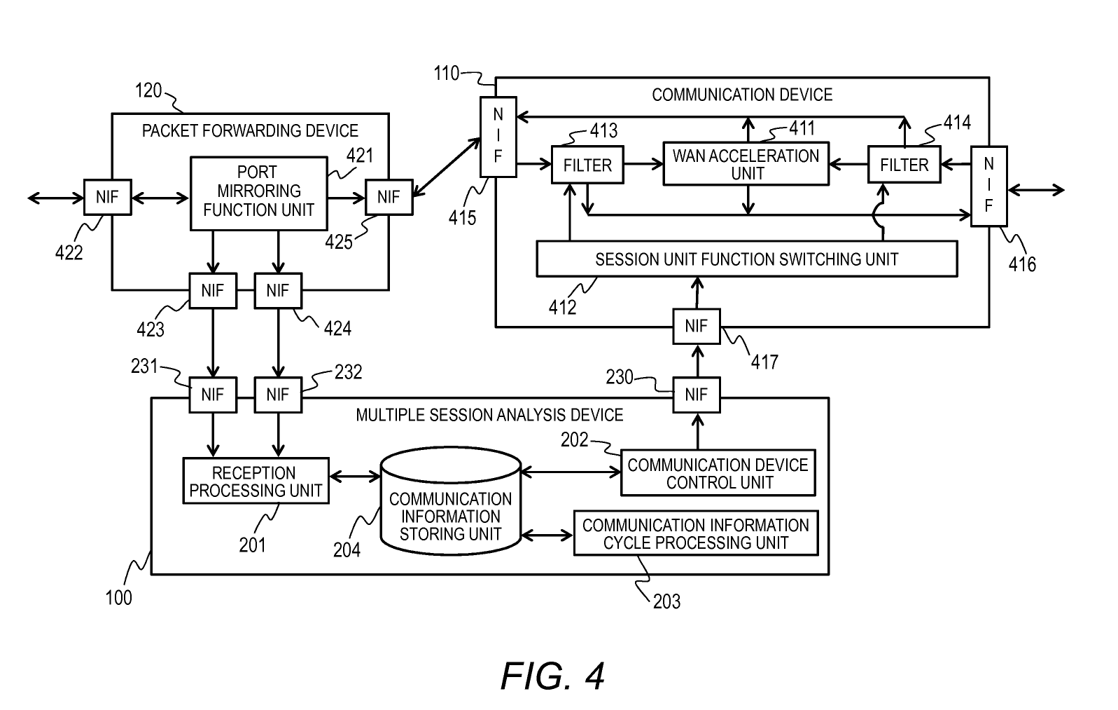

FIG. 4 shows a block configuration example of functions of a system including a multiple session analysis device 100 of the present embodiment. The system further includes the communication device 110 controlled by the multiple session analysis device 100, and the packet forwarding device 120 that transmits mirror packets to the multiple session analysis device 100.

The communication device 110 is a WAN accelerator, and includes a WAN acceleration processing unit 411, a session unit function switching unit 412, a filter 413, a filter 414, a NIF 415, a NIF 416, and a NIF 417. The packet forwarding device 120 includes a port mirroring functional unit 421, a NIF 422, a NIF 423, a NIF 424, and a NIF 425. The functional units of the communication device 110 and the packet forwarding device 120 are formed by the processor operating according to programs stored in the memory or by specialized logic circuits.

Details of operations of the respective units of the multiple session analysis device 100 will be described later, but here, the functions of the respective units will be described in a simple manner. The NIF 231 and the NIF 232 transmit the mirror packets received from the packet forwarding device 120 to the reception processing unit 201.

The reception processing unit 201, using the header information of the mirror packets received from the NIF 231 and the NIF 232, searches the communication information storing unit 204 for session information of sessions to which the mirror packet belongs.

If such information is stored, the reception processing unit 201 analyzes session information stored in the communication information storing unit 204 and session information in header information of the mirror packets, and updates the session information stored in the communication information storing unit 204. If the session information of a session to which the mirror packet belongs is not stored in the communication information storing unit 204, then the reception processing unit 201 stores the session information of the session in the communication information storing unit 204.

The communication information cycle processing unit 203 checks the session information of the respective sessions stored in the communication information storing unit 204 in order, determines whether to activate or deactivate the functions of the communication device 110 for each session, and updates the session information including the determination results.

The communication device control unit 202 checks the session information of the respective sessions stored in the communication information storing unit 204 in order, and if it is determined that the functions of the communication device 110 should be activated, then the communication device control unit 202 instructs the communication device 110 to activate the functions for that session. If it is determined that the functions of the communication device 110 should be deactivated, then the communication device control unit 202 instructs the communication device 110 to deactivate the functions for that session.

The communication information storing unit 204 receives update operations for session information from the reception processing unit 201, the communication device control unit 202, and the communication information cycle processing unit 203 in parallel.

The WAN acceleration processing unit 411 provides a proxy function in which TCP communication of packets received from the NIF 416 through the filter 414 is terminated, and packets are transmitted to the NIF 415 by TCP communication in which a higher speed congestion control algorithm is executed. The WAN acceleration processing unit 411 terminates TCP communication of packets received from the NIF 415 through the filter 413, and transmits packets to the NIF 416 by TCP communication in an algorithm known as RENO is executed.

The session unit function switching unit 412 issues a command to the filter 413 and the filter 414 to cause packets of a session for which the WAN acceleration processing function is activated to pass through the WAN acceleration processing unit 411 and prevent packets of a session for which the WAN acceleration function is deactivated from passing through the WAN acceleration processing unit 411, on the basis of a function switching command received from the multiple session analysis device 100 through the NIF 417. WAN acceleration of packets is realized by causing the packets to pass through the WAN acceleration processing unit 411.

If a command is received from the session unit function switching unit 412 to activate the WAN acceleration function for a session to which a packet received from the NIF 415 belongs, then the filter 413 sends the packet to the WAN acceleration processing unit 411. If the filter 413 receives a command to deactivate the WAN acceleration function, then the packet is sent to the NIF 416.

If a command is received from the session unit function switching unit 412 to activate the WAN acceleration function for a session to which a packet received from the NIF 416 belongs, then the filter 414 sends the packet to the WAN acceleration processing unit 411. If the filter 414 receives a command to deactivate the WAN acceleration function, then the packet is sent to the NIF 415.

The port mirroring functional unit 421 transmits packets received from the NIF 422 to the NIF 425, and transmits the same packet to the NIF 423 as a mirror packet. Additionally, the port mirroring functional unit 421 transmits packets received from the NIF 425 to the NIF 422, and transmits the same packet to the NIF 424 as a mirror packet.

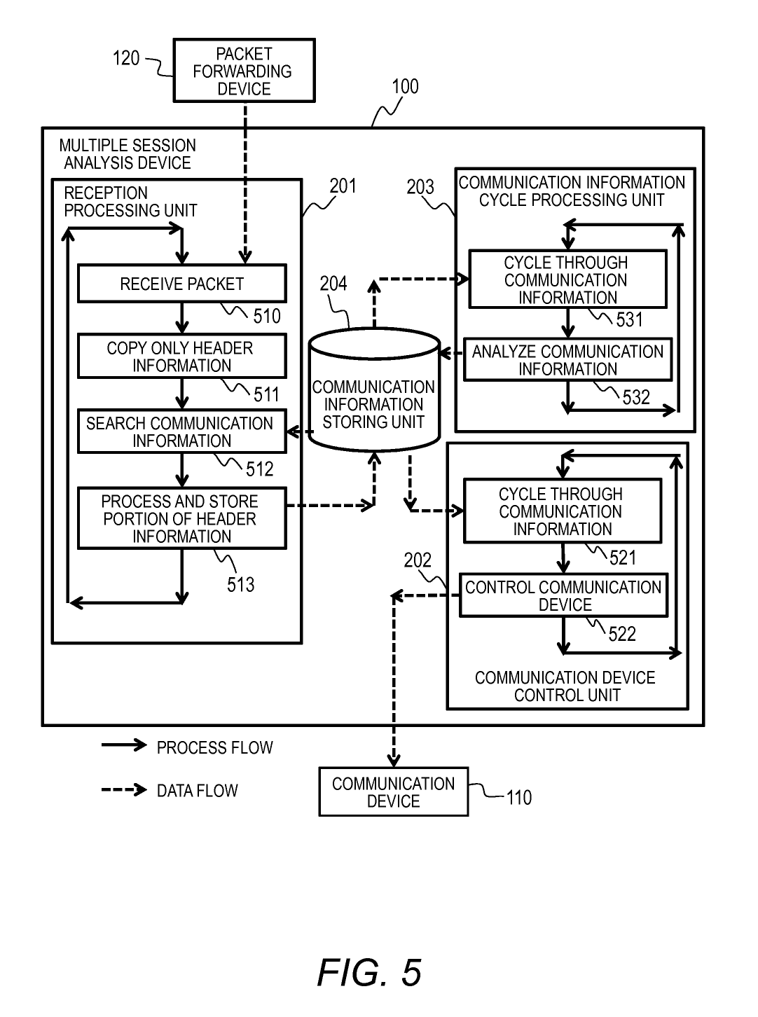

FIG. 5 shows details of a block function configuration example of the multiple session analysis device 100. In the multiple session analysis device 100, the reception processing unit 201, the communication device control unit 202, and the communication information cycle processing unit 203 operate in parallel.

The reception processing unit 201 receives (510) a mirror packet from the packet forwarding device 120, and copies (511) only the header information of the mirror packet. The reception processing unit 201 searches the communication information storing unit 204 for session information of a session to which the mirror packet belongs by a communication information search process (512). The reception processing unit 201 processes (513) session information of the searched mirror packet and header information of the mirror packet, and stores (513) the processed information and a portion of the header information of the mirror packet to the communication information storing unit 204.

The communication information cycle processing unit 203 cycles through the session information of the respective sessions stored in the communication information storing unit 204 by the communication information cycle process (531), and analyzes session information including a determination of whether to activate or deactivate functions of the communication device 110 by the communication information analyzing process 532 performed on the session information of each session. The analyzed session information is stored in the communication information storing unit 204.

The communication device control unit 202 cycles through session information of the respective sessions stored in the communication information storing unit 204 by a communication information cycle process (521), and refers to determination results of whether to activate or deactivate the WAN acceleration function of the communication device 110 included in the session information of each session. The communication device control unit 202 controls the activation/deactivation of the WAN acceleration function of the communication device 110 for each session on the basis of the determination results.

In the present embodiment, by performing in parallel processes of the reception processing unit 201 and the communication information cycle processing unit 203, reducing the processes performed by the reception processing unit 201, and having the communication information cycle processing unit 203 perform processes for which a larger amount of time can be taken, it is possible to improve packet reception performance of the reception processing unit 201, which is a bottleneck for the performance of the multiple session analysis device 100.

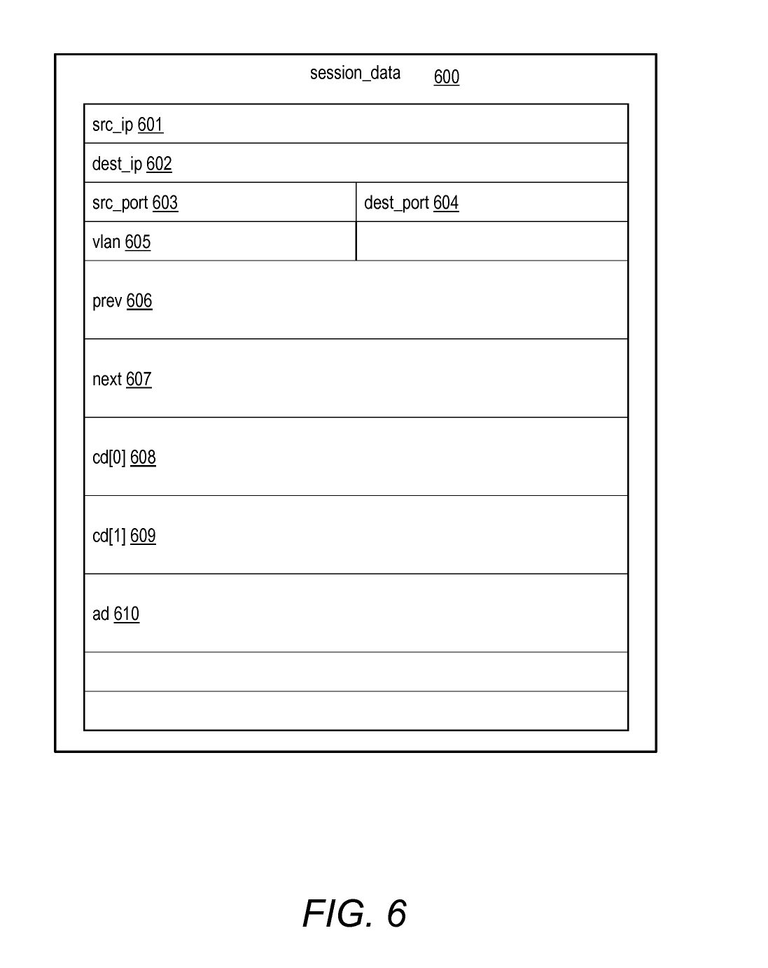

FIGS. 6 to 10 show data structures stored in the communication information storing unit 204.

FIG. 6 shows the data structure of a session_data structure 600 storing management information for each session, generated by the reception processing unit 201. src_ip 601 is the IP address of the left-side computer. dest_ip 602 is the IP address of the right-side computer. src_port 603 is the port number of the left-side computer. dest_port 604 is the port number of the right-side computer. vlan 605 is the VLAN number.

prey 606 and next 607 are pointer variables to session_data structures 600. cd[0] 608 and cd[1] 609 are pointer variables to capture_data structures 700. ad 610 is a pointer variable to the analysis_data structure 800.

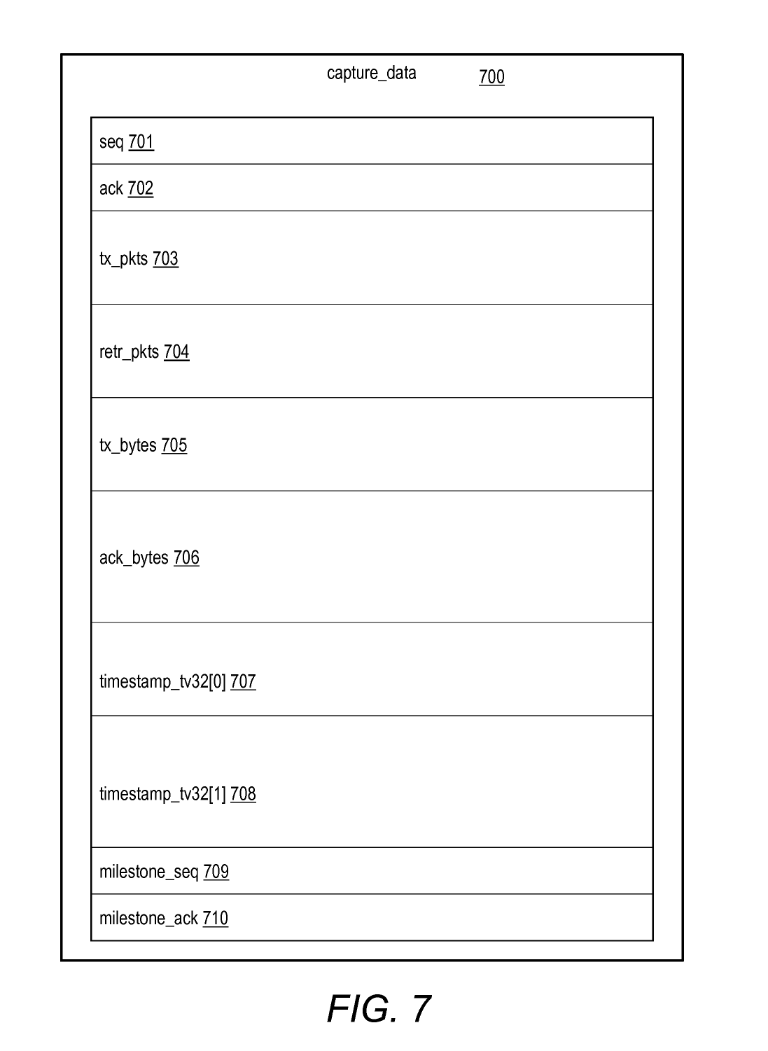

FIG. 7 shows the data structure of the capture_data structure 700, which is session information generated and updated by the reception processing unit 201. capture_data structures 700 are generated respectively for right-direction and left-direction packets.

seq 701 is an end number of the sequence numbers of the mirror packets that have been received so far. ack 702 is an end number of the ACK numbers of the mirror packets that have been received so far. tx_pkts 704 is the number of mirror packets that have been received so far. retr_pkts 704 is the number of packets retransmitted by TCP among the mirror packets received so far.

tx_bytes 705 is the total payload size of mirror packets received so far. ack_bytes 706 is the total number of bytes acknowledged by mirror packets received so far. timestamp_tv32[0] 707 is a time stamp of the first mirror packet in which seq 701 has exceeded milestone_seq 709.

timestamp_tv32[1] 708 is a time stamp of the first mirror packet in which ack 702 has exceeded milestone_ack 710.

milestone_seq 709 is a milestone SEQ number used when measuring the round-trip delay time between transmitting/receiving terminals, and milestone_ack 710 is a milestone ACK number used when measuring the round-trip delay time between transmitting/receiving terminals. By setting the milestone SEQ number to be the same as the milestone ACK number, it is possible to distinguish ACK packets from packets for which the target SEQ number has been transmitted.

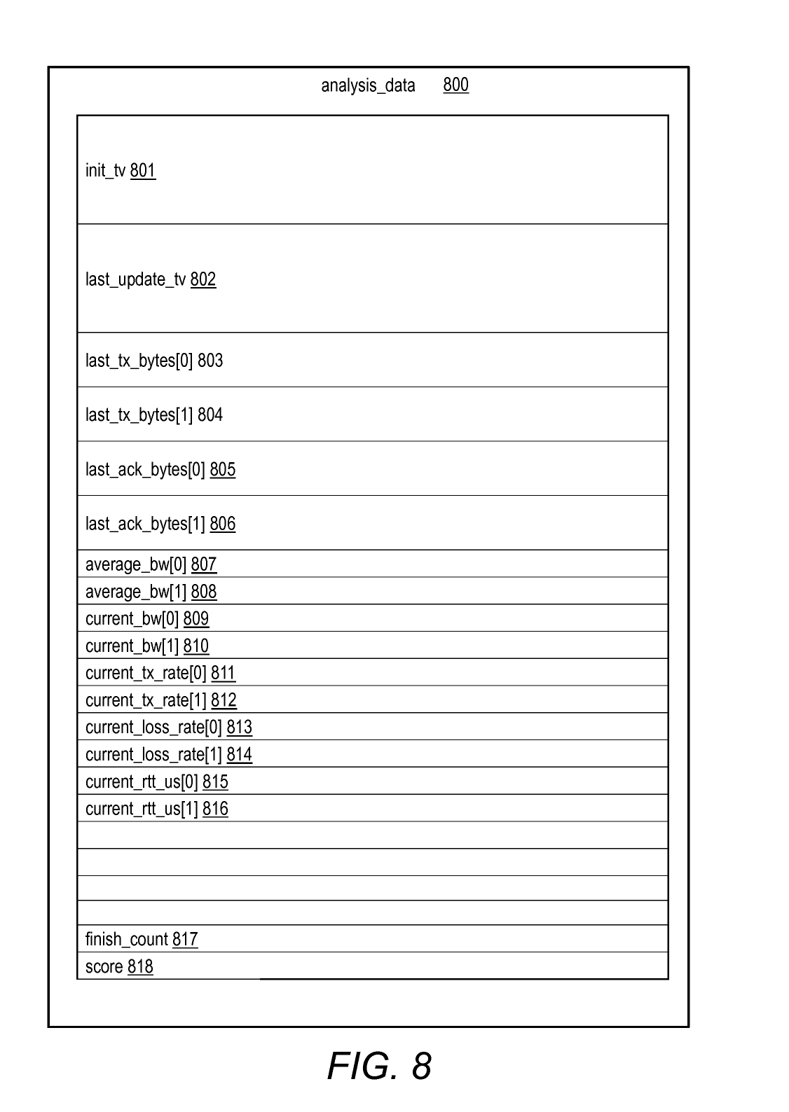

FIG. 8 shows the data structure of the analysis_data structure 800, which is session information generated by the reception processing unit 201 and updated by the communication information cycle processing unit 203. init_tv 801 is a time stamp of the mirror packet first received during the session. last_update_tv 802 is the time at which the communication information cycle processing unit 203 previously updated the session information.

last_tx_byte[0] 803 is the total payload size of a mirror packet of a right-direction packet received up to when the communication information cycle processing unit 203 previously updated the session information. last_tx_byte[1] 804 is the total payload size of a mirror packet of a left-direction packet received up to when the communication information cycle processing unit 203 previously updated the session information.

last_ack_bytes[0] 805 is the total number of bytes acknowledged by a mirror packet of a right-direction packet received up to when the communication information cycle processing unit 203 previously updated the session information.

last_ack_bytes[1] 806 is the total number of bytes acknowledged by a mirror packet of a left-direction packet received up to when the communication information cycle processing unit 203 previously updated the session information.

average_bw[0] 807 is the current average communication speed of right-direction packets since init_tv 801. average_bw[1] 808 is the current average communication speed of left-direction packets since init_tv 801.

current_bw[0] 809 is the current average communication speed of right-direction packets since the communication information cycle processing unit 203 previously updated the session information. current_bw[1] 810 is the current average communication speed of left-direction packets since the communication information cycle processing unit 203 previously updated the session information.

current_tx_rate[0] 811 is the current communication speed of right-direction packets including retransmitted packets since the communication information cycle processing unit 203 previously updated the session information. current_tx_rate[1] 812 is the current communication speed of left-direction packets including retransmitted packets since the communication information cycle processing unit 203 previously updated the session information. current_loss_rate[0] 813 is the retransmission rate of right-direction packets and current_loss_rate[1] 814 is the retransmission rate of left-direction packets.

current_rtt_us[0] 815 is the round-trip delay time in microseconds between a terminal on the network 140 and the packet forwarding device 120, which are transmitting/receiving packets. current_rtt_us[1] 816 is the round-trip delay time in microseconds between a terminal on the network 130 and the packet forwarding device 120, which are transmitting/receiving packets. current_rtt_us[0] 815 is referred to as the right-direction round-trip delay time and current_rtt_us[1] 816 is referred to as the left-direction round-trip delay time.

finish_count 817 is a flag variable used when determining whether or not a session has ended. When a FIN packet is received, the value of finish_count 817 is changed. Session information for sessions that have ended is deleted by the communication information cycle processing unit 203. The communication information cycle processing unit 203 also deletes session information that has not been updated for a prescribed period of time. score 818 is a point value indicating the necessity or lack thereof of communication device 110 functions.

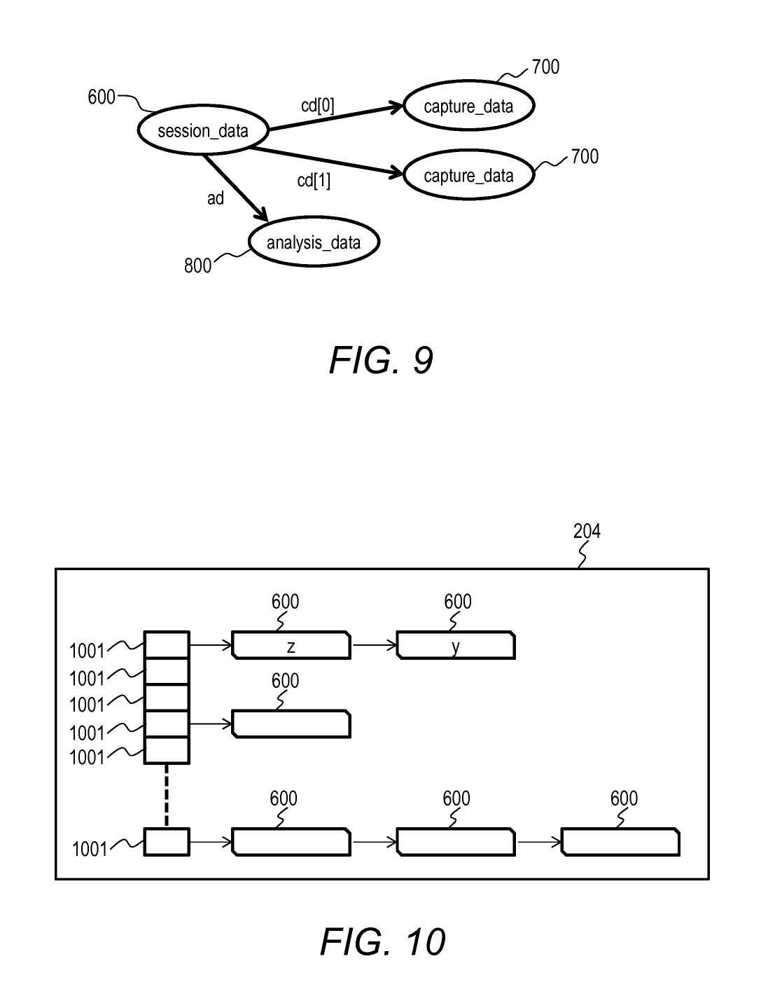

FIG. 9 indicates the nature of the relationship between the session_data structure 600, the capture_data structure 700, and the analysis_data structure 800.

When a new session is started, the reception processing unit 201 generates the session_data structure 600, two capture_data structures 700 on the left and right, and the analysis_data structure 800. When a new packet is received from this session, the reception processing unit 201 updates the capture_data structure 700. The communication information cycle processing unit 203 updates the analysis_data structure 800 in repeated cycle processing.

The capture_data structure 700 of the right-direction packet is referenced by a pointer cd[0] 608 of the session_data structure, which stores right-direction packet information. The capture_data structure 700 of the left-direction packet is referenced by a pointer cd[1] 609 of the session_data structure, which stores left-direction packet information. The analysis_data structure 800 is referenced by a pointer ad 610 of the session_data structure 600.

FIG. 10 shows how the session_data structure 600 having pointers to the capture_data structure 700 and the analysis_data structure 800 is arranged in the communication information storing unit 204. By such an arrangement, it is possible to perform a search on the data structures 600 to 800 of sessions to which the mirror packet belongs in the communication information storing unit 204.

The communication information storing unit 204 stores session information in an open hash table structure. The open hash table structure is expressed as an array in which two million pointers 1001 referencing the session_data structure 600 storing data of respective sessions are aligned. Each session_data structure 600 further includes pointers prey 606 and next 607 referencing other session_data structures 600.

The relation between the session_data structure 600 of the session and the pointer 1001 referencing the session_data structure 600 is determined by the following method. A value obtained by executing a hash function md5 on a bit array having src_ip 601, dest_ip 602, src_port 603, dest_port 604, and vlan 605 is divided by two million, which is the number of elements in the array, and the remainder x thereof is determined.

The x-th pointer 1001 of the array is selected as the pointer referencing the session_data structure 600. Furthermore, the pointer prey 606 of the session_data structure 600 is determined so as to point to the address of the x-th pointer 1001 of the array.

In a hypothetical example, the remainder calculated from a certain session_data structure 600y is determined to be x, and the x-th pointer 1001 references another session_data structure 600z. In such a case, the pointer next 607 of the session_data structure 600z references the session_data structure 600y, and the pointer prey 606 of the session_data structure 600y references z.

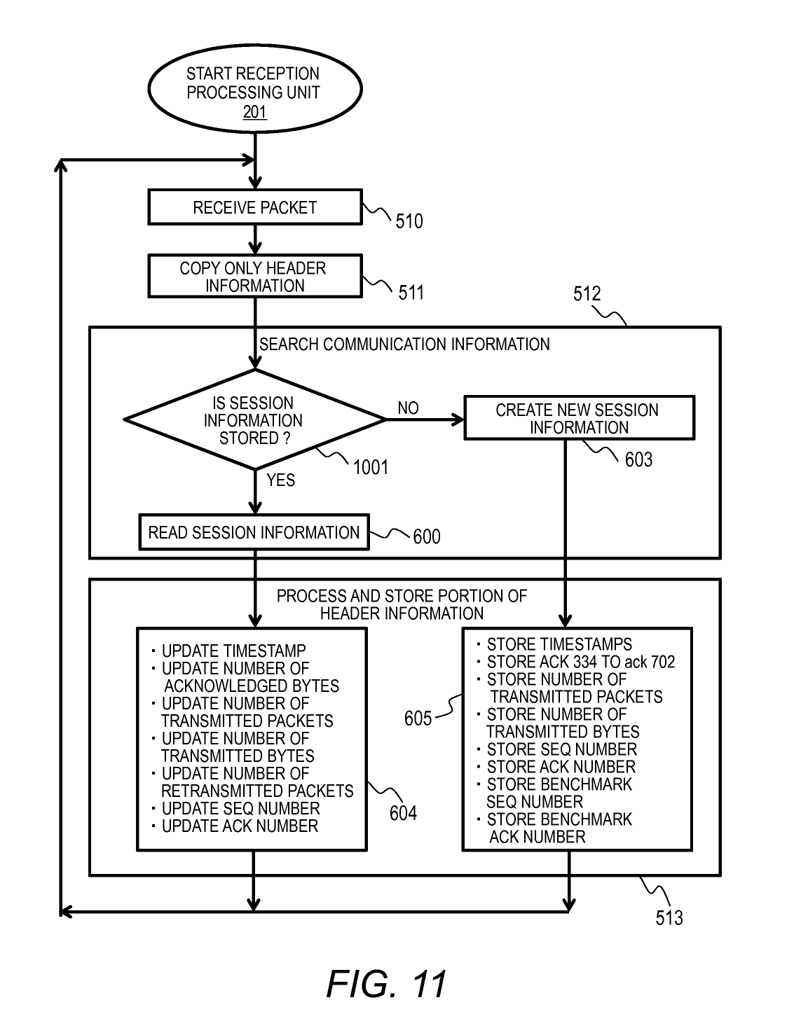

FIG. 11 is a flow chart showing operation details of the reception processing unit 201. The reception processing unit 201 receives mirror packets (510), and stores only the header information in the memory (511). By storing only a portion of the information of the packet, it is possible to save on memory consumption and improve processing performance.

Next, the reception processing unit 201 searches (512) for session information of the mirror packet in the communication information storing unit 204. First, the reception processing unit 201 performs a search (1001) on the mirror packet for session information determined to be the same session.

In the case of mirror packets received from the NIF 231, if among the header information of the mirror packet SIP 323 matches src_ip 601,

DIP 324 matches dest_ip 602, src_port 331 matches src_port 603, dst_port 332 matches dest_port 604, and VID 318 matches vlan 605, the reception processing unit 201 determines that the session information is of the same session as the mirror packet.

In the case of mirror packets received from the NIF 232, if, among the header information of the mirror packet, SIP 323 matches dest_ip 602, DIP 324 matches src_ip 601, src_port 331 matches dest_port 604, dst_port 332 matches src_port 603, and VID 318 matches vlan 605, the reception processing unit 201 determines that the session information is of the same session as the mirror packet.

The reasons that the conditions for determining that the sessions are the same differ between the NIF 231 and the NIF 232 in order to allow the determination to be made that right-direction and left-direction packets included in the same session belong to the same session.

If, as a result of the search, it is found that session information of the same session as that of the mirror packet is saved (1001:Yes), then the reception processing unit 201 reads the session information (600). If, as a result of the search, it is found that session information of the same session as that of the mirror packet is not saved (1001:No), then the reception processing unit 201 creates new session information in the communication information storing unit 204 (603). The reception processing unit 201 generates the session_data structure 600, two capture_data structures 700, and the analysis_data structure 800, and saves these in the communication information storing unit 204.

Next, the reception processing unit 201 processes and stores a portion of the header information (513). Specifically, if corresponding session information is stored, the reception processing unit 201 updates the session information (604). The reception processing unit 201 increments tx_pkts 703 by 1, for example. If SEQ 333 is greater than seq 701, then the reception processing unit 201 adds the difference to tx_bytes 705, and updates seq 701 and timestamp_tv32[0] 707.

If ACK 334 is greater than ack 702, then the reception processing unit 201 adds the difference to ack_bytes 702, and updates ack 702 and timestamp_tv32[1] 708. If SEQ 333 is less than seq 801, or SEQ 333 is equal to seq 801 and the payload length is 0, then the reception processing unit 201 increments retr_pkts 704 by 1.

If no corresponding session information is stored, then the reception processing unit 201 stores new information in a structure of the communication information storing unit 204 (605). The reception processing unit 201 stores the mirror packet time stamps as timestamp_tv32[0] 707 and timestamp_tv32[1] 708, for example. The reception processing unit 201 sets tx_pkts 703 to 1. The reception processing unit 201 stores the payload length in tx_bytes 705, SEQ 333 in seq 701, and ACK 334 to ack 702.

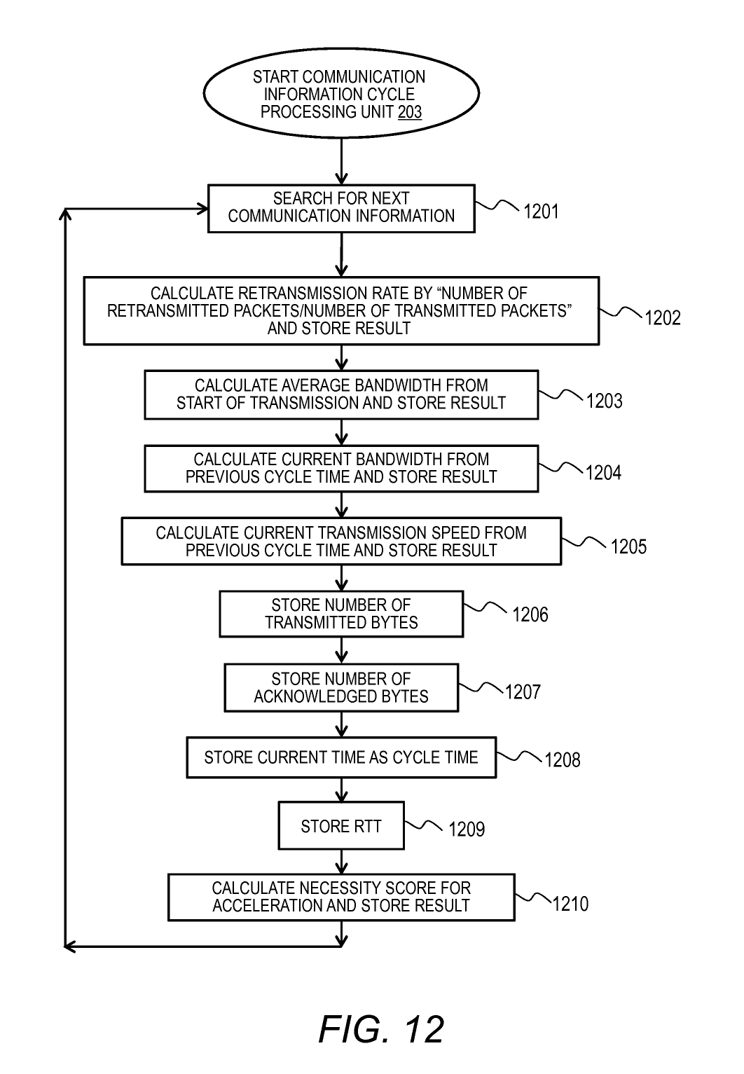

FIG. 12 is a flow chart showing operation details of the communication information cycle processing unit 203. The communication information cycle processing unit 203 performs a process on session information stored in the communication information storing unit 204 in order. This is referred to as cycling through the communication information.

First, the communication information cycle processing unit 203 searches for the next session information (1201). If there is no next session information, the communication information cycle processing unit 203 returns to the first step. If there is not even one session information, then the communication information cycle processing unit 203 stands by until new session information is stored.

If session information is found, then the communication information cycle processing unit 203 calculates information necessary to control the communication device 110 from the session information from the previous cycle and the current session information and saves this information (1202-1205).

Specifically, the communication information cycle processing unit 203 calculates the retransmittance rate as retr_pkts 704/tx_pkts 703, and saves retransmittance rate for the right-direction packet in current_loss_rate[0] 813 and the retransmittance rate for the left-direction packet in current_loss_rate[1] 814 (1202).

The communication information cycle processing unit 203 calculates the average bandwidth from the start of communication as ack_bytes 705/(current time−init_tv 801), and stores the right-direction average bandwidth in average_bw[0] 807, and the left-direction average bandwidth in average_bw[0] 808 (1203).

The communication information cycle processing unit 203 calculates the current bandwidth from the previous cycle as ack_bytes 706/(current time−last_update_tv 802), and stores the right-direction current bandwidth in current_bw[0] 809, and the left-direction current bandwidth in current_bw[1] 810 (1204).

The communication information cycle processing unit 203 calculates the current communication speed from the previous cycle as tx_bytes 705/(current time−last_update_tv 802), and stores the right-direction current communication speed in current_tx_rate[0] 811, and the left-direction current communication speed in current_tx_rate[1] 812 (1205).

Next, the communication information cycle processing unit 203 searches for the current session information (1206-1209).

Specifically, the communication information cycle processing unit 203 stores the right-direction tx_bytes 705 in last_tx_bytes[0] 803 and the left-direction tx_bytes 705 in last_tx_bytes[1] 804 (1206).

The communication information cycle processing unit 203 stores the right-direction ack_bytes 706 in last_ack_bytes[0] 805 and the left-direction ack_bytes 706 in last_ack_bytes[1] 806 (1207).

The communication information cycle processing unit 203 saves the current time in last_update_tv 802 as the cycle time (1208).

The communication information cycle processing unit 203 calculates the round-trip delay of communication and saves it (1209). Specifically, the communication information cycle processing unit 203 calculates the right-direction round-trip delay as <right-direction session_data structure timestamp_tv32[1] 708>−<left-direction session_data structure timestamp_tv32[0] 707> and saves the result in current_rtt_us[0] 815.

Additionally, the communication information cycle processing unit 203 calculates the left-direction round-trip delay as <left-direction session_data structure time stamp_tv32[1] 708 >−<right-direction session_data structure timestamp_tv32[0] 707> and saves the result in current_rtt_us[1] 816.

Finally, the communication information cycle processing unit 203 calculates the necessity score for the WAN acceleration function of the communication device 110 and stores it in score 818 (1210).

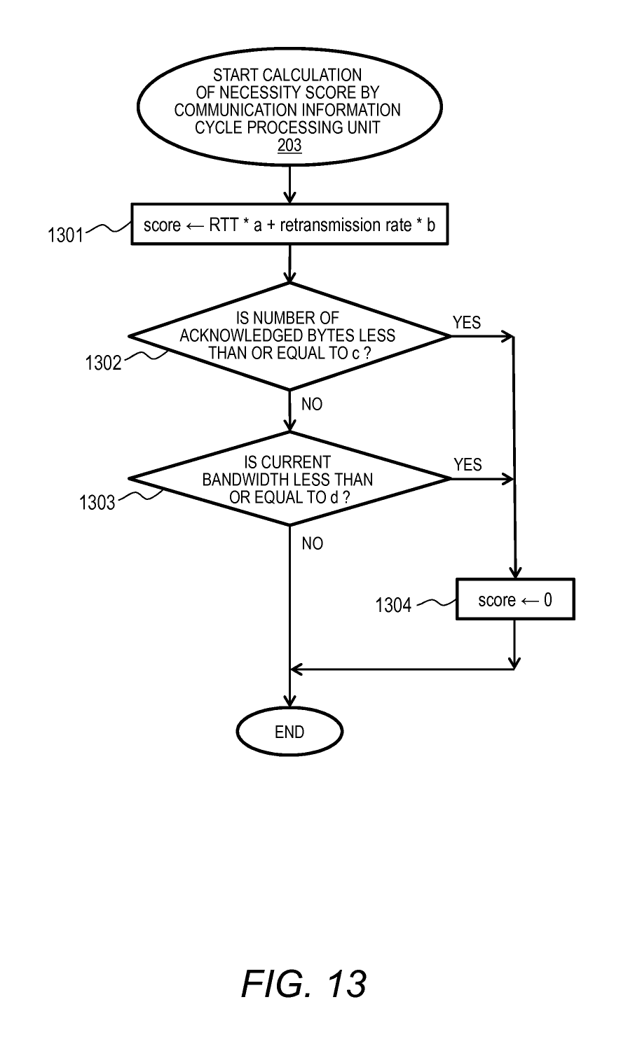

FIG. 13 is a flow chart showing an operation (1210) performed by the communication information cycle processing unit 203 of calculating the necessity score for the WAN acceleration function of the communication device 110.

First, the communication information cycle processing unit 203 calculates the necessity score for the right-direction packet as (current_rtt_us[0] 815+current_rtt_us[1] 816)*a+current_loss_rate[0] 813*b.

The communication information cycle processing unit 203 stores the calculated necessity score in score 818 (1301).

a and b are modifiable parameters and a=0.001 and b=1, for example. According to this formula, the necessity score is set high for sessions in which communication delay and packet loss due to the network are large, and WAN acceleration is prioritized for such sessions.

However, if last_ack_bytes[1] 805 is c or less (1302), then the communication information cycle processing unit 203 sets score 818 as 0. This is because if the communication volume from the start of communication is small, then there is no need to activate WAN acceleration.

Also, if current_bw[0] 809 is d or less (1303), then the communication information cycle processing unit 203 sets score 818 as 0 (1304). This is because if the current communication volume is small, then there is no need to activate WAN acceleration.

Next, the communication information cycle processing unit 203 similarly calculates the necessity score for the left-direction packet, adds this value to the necessity score for the right-direction packet, and stores the total in score 818. When controlling a communication device 110 that handles right-direction and left-direction packets together, effective control can be realized by calculating the necessity scores of packets in both directions and adding them together.

The communication information cycle processing unit 203 determines whether or not to perform the WAN acceleration function on the session on the basis of the calculated necessity score. If the necessity score is less than a threshold, for example, then the communication information cycle processing unit 203 determines that there is no need to perform the WAN acceleration function in the session. Alternatively, the communication information cycle processing unit 203 selects a predetermined number or less of sessions having a high necessity score are determines that the WAN acceleration function needs to be performed on these sessions. The necessity determination based on the necessity score may be performed by the communication device control unit 202.

By calculating the necessity score, it is possible to prioritize the WAN acceleration function for sessions for which it is deemed necessary to perform the WAN acceleration function. The calculation of the necessity score is not limited to the function above. A portion of the formula may be used, for example. The communication information cycle processing unit 203 may use only one of the loss rate or delay time and may determine the necessity score without taking into consideration the communication volume, for example.

By the above mechanism, the multiple session analysis device 100 can cause the communication device 110 to function effectively on a network handling multiple sessions without increasing the number of sessions actually handled by the communication device 110. In the method of controlling the communication function of the present embodiment, the necessity of performing the communication function may be determined for each communication that is not a TCP session. The multiple session analysis device 100 may display, in an output device (not shown) for a manager, information including determination results without controlling the WAN acceleration function of the communication device 110 or while controlling the WAN acceleration function. This similarly applies to other embodiments.

The WAN acceleration processing unit 411 of the communication device 110 requires a transmission buffer of 16 MB per session, for example.

In such a case, the WAN acceleration processing unit 411 would require 16 GB of memory in order to process 1,000 sessions, 160 GB of memory in order to process 10,000 sessions, and 16 TB of memory in order to process 1,000,000 sessions.

Meanwhile, the multiple session analysis device 100 consumes a total of 320 bytes of data per session as management information for the session, including one session_data 600, two capture_data 700, and one analysis_data 800. There are a total of 1,000,000 open hash table pointers 1001, and with each pointer taking up 64 bits, the amount of memory necessary to manage 1,000 sessions is 8320 KB, and 328 MB for 1,000,000 sessions.

In a network where there are 1,000,000 sessions of which 1,000 sessions would benefit from the WAN acceleration function, then without the use of the multiple session analysis device 100, the amount of memory needed in order to effectively accelerate 1,000 sessions would be 16 TB, but with the use of the multiple session analysis device 100, the amount of memory required would be 16,328 MB, a large reduction in computer resources used.

### Embodiment 2

Embodiment 1 showed a hardware configuration in which the multiple session analysis device 100 is separate from the communication device 110. In the present embodiment, an example will be described in which a virtual multiple session analysis device 16100, a virtual communication device 16110, and a virtual packet forwarding device 16120 are incorporated as virtual machines in, the same computer 1400. Unless otherwise noted, configurations similar to those of Embodiment 1 are assigned the same reference characters and descriptions thereof are omitted.

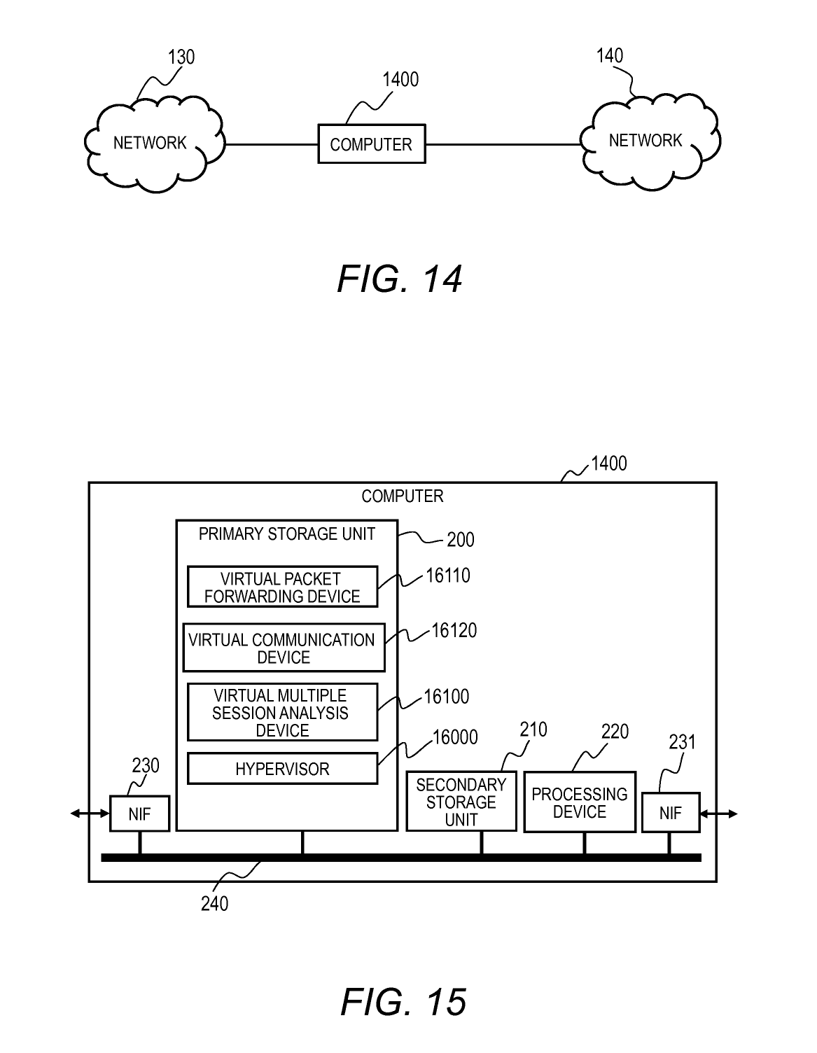

FIG. 14 is a configurational example of a network system including a computer 1400 of Embodiment 2. The computer 1400 is connected to a network 130 and a network 140. Unlike Embodiment 1, a packet forwarding device 120, a communication device 110, and a multiple session analysis device 100 are not disposed between the network 130 and the network 140 as independent devices, but are installed as virtual machines in the computer 1400.

FIG. 15 shows a hardware configuration drawing of the computer 1400 in Embodiment 2. Programs of a hypervisor 16000, the virtual packet forwarding device 16120, the virtual communication device 16110, and the virtual multiple session analysis device 16100 are stored in the primary storage unit of the computer 1400. The hypervisor 16000 logically separates hardware resources including the primary storage unit 200 and the processing device 220, and the separated resources are allocated to the virtual packet forwarding device 16120, the virtual communication device 16110, and the virtual multiple session analysis device 16100. In this manner, the virtual machines can operate on one computer 1400.

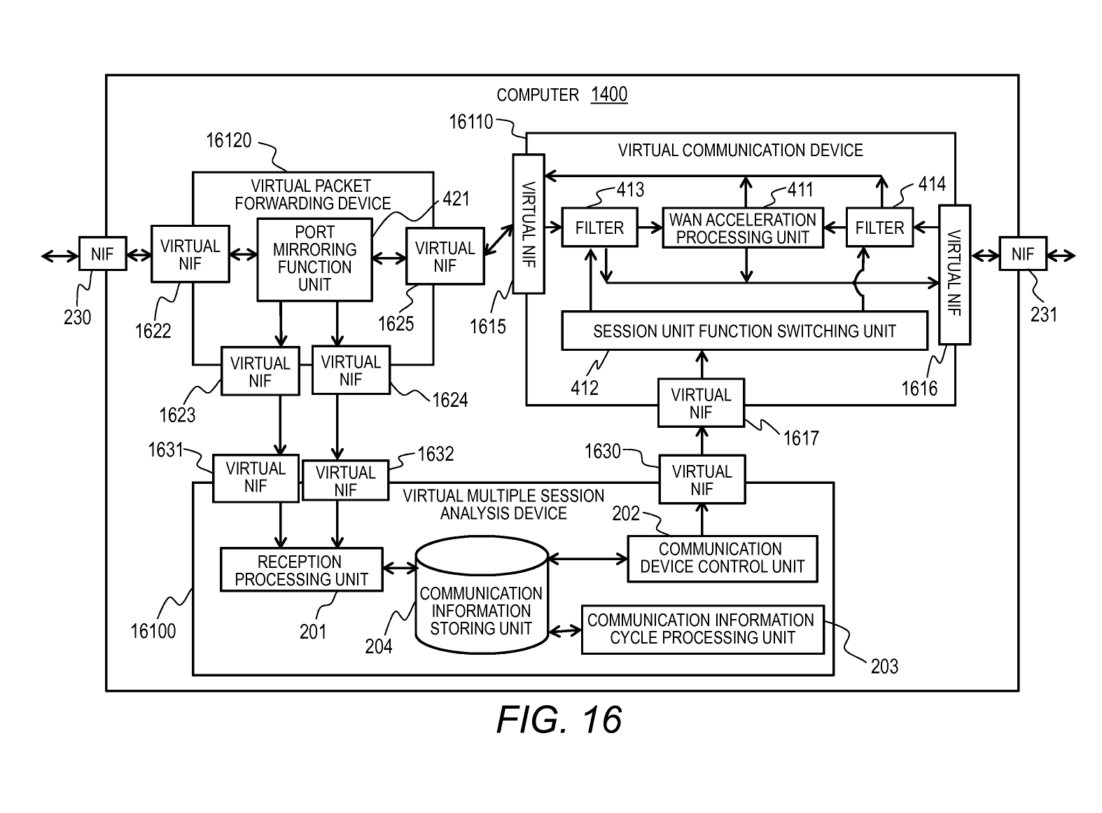

FIG. 16 shows a function block configuration example of the computer 1400 in Embodiment 2. The computer 1400 includes the virtual packet forwarding device 16120 having an equivalent function to the packet forwarding device 120 of Embodiment 1, the virtual communication device 16110 having an equivalent function to the communication device 110 of Embodiment 1, and the virtual multiple session analysis device 16100 having an equivalent function to the multiple session analysis device 100 of Embodiment 1.

A virtual NIF 1622 transfers packets between a NIF 230 and a port mirroring functional unit 421. A virtual NIF 1625 transfers packets between the port mirroring functional unit 421 and a virtual NIF 1615. A virtual

NIF 1623 forwards packets from the port mirroring functional unit 421 to a virtual NIF 1631. A virtual NIF 1624 forwards packets from the port mirroring functional unit 421 to a virtual NIF 1632.

A virtual NIF 1615 transfers packets between a virtual NIF 1625 and a filter 413. A virtual NIF 1616 transfers packets between a filter 414 and a

NIF 231. A virtual NIF 1617 forwards packets from a virtual NIF 1630 to a session unit function switching unit 412.

A virtual NIF 1631 forwards packets from a virtual NIF 1623 to a reception processing unit 201. A virtual NIF 1632 forwards packets from a virtual NIF 1624 to the reception processing unit 201. A virtual NIF 1630 forwards packets from the communication device control unit 202 to the virtual NIF 1617.

Here, an example is shown in which the virtual packet forwarding device 16120, the virtual communication device 16110, and the virtual multiple session analysis device 16100 are installed as virtual machines in one computer 1400, but some or all of the virtual machines may be installed in different computers. Also, a configuration may be adopted in which some of these are realized as virtual machines and some as independent devices.

The present embodiment has an advantage compared to Embodiment 1 in that what was realized as a plurality of physical devices in Embodiment 1 is realized as one physical device in Embodiment 2, which reduces costs. Also, by installing the respective devices as virtual devices, it is easier to deploy the system more extensively, such as in the cloud.

### Embodiment 3

In Embodiment 2, a configuration was described in which a virtual multiple session analysis device 16100, a virtual communication device 16110, and a virtual packet forwarding device 16120 are incorporated as virtual machines in the same computer 1400. In the present embodiment, a configuration will be described in which a multiple session analysis unit 18100, a communication device functional unit 18110, and a packet copy unit 18120 are installed in one communication device 1700. Unless otherwise noted, configurations similar to those of Embodiment 1 and Embodiment 2 are assigned the same reference characters and descriptions thereof are omitted.

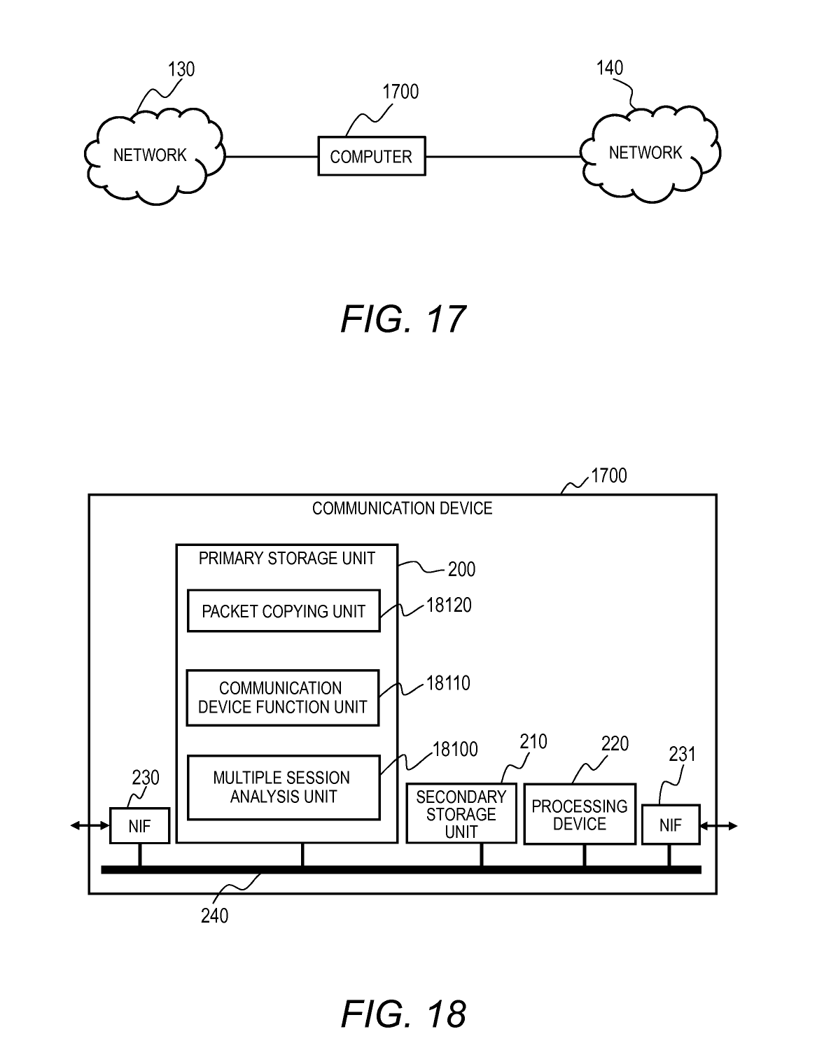

FIG. 17 is a configurational example of a network system including the communication device 1700 of Embodiment 3. The communication device 1700 is connected to a network 130 and a network 140. Unlike Embodiment 1, a packet forwarding device 120, a communication device 110, and a multiple session analysis device 100 are not disposed between the network 130 and the network 140 as independent devices, but are installed as functions of the communication device 1700.

FIG. 18 shows a hardware configuration drawing of the communication device 1700 in Embodiment 3. The primary storage unit of the communication device 1700 stores programs of the packet copy unit 18120, the communication device functional unit 18110, and the multiple session analysis unit 18100.

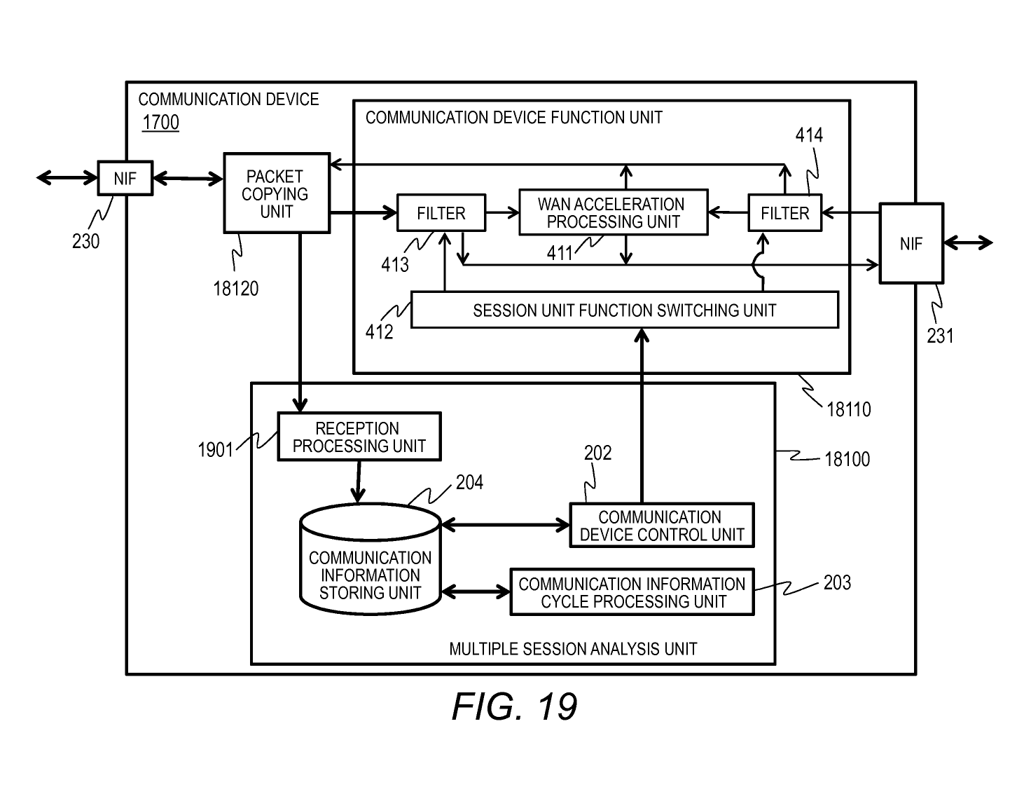

FIG. 19 shows a function block configuration example of the communication device 1700 in Embodiment 3. The communication device 1700 includes the packet copy unit 18120 having an equivalent function to the packet forwarding device 120 of Embodiment 1, the communication device functional unit 18110 having an equivalent function to the multiple session analysis device 100 of Embodiment 1, and the multiple session analysis unit 18100 having an equivalent function to the multiple session analysis device 100 of Embodiment 1.

The packet copy unit 18120 copies packets received from a NIF 230 and forwards them to both a filter 413 and a reception processing unit 1901. Also, the packet copy unit 18120 copies packets received from a filter 414 and forwards them to both the NIF 230 and the reception processing unit 1901.

In the present embodiment, the packet copy unit 18120, the communication device functional unit 18110, and the multiple session analysis unit 18100 are installed in one device, and has better processing performance compared Embodiment 2 in which these functions are installed as virtual machines.

### Embodiment 4

In Embodiments 1 to 3, an example was described in which the multiple session analysis device controls a communication device (network appliance) having a WAN acceleration function. In the present embodiment, an example will be described in which the multiple session analysis device controls a communication device (network appliance) having a firewall function. Unless otherwise noted, configurations similar to those of Embodiments 1 to 3 are assigned the same reference characters and descriptions thereof are omitted.

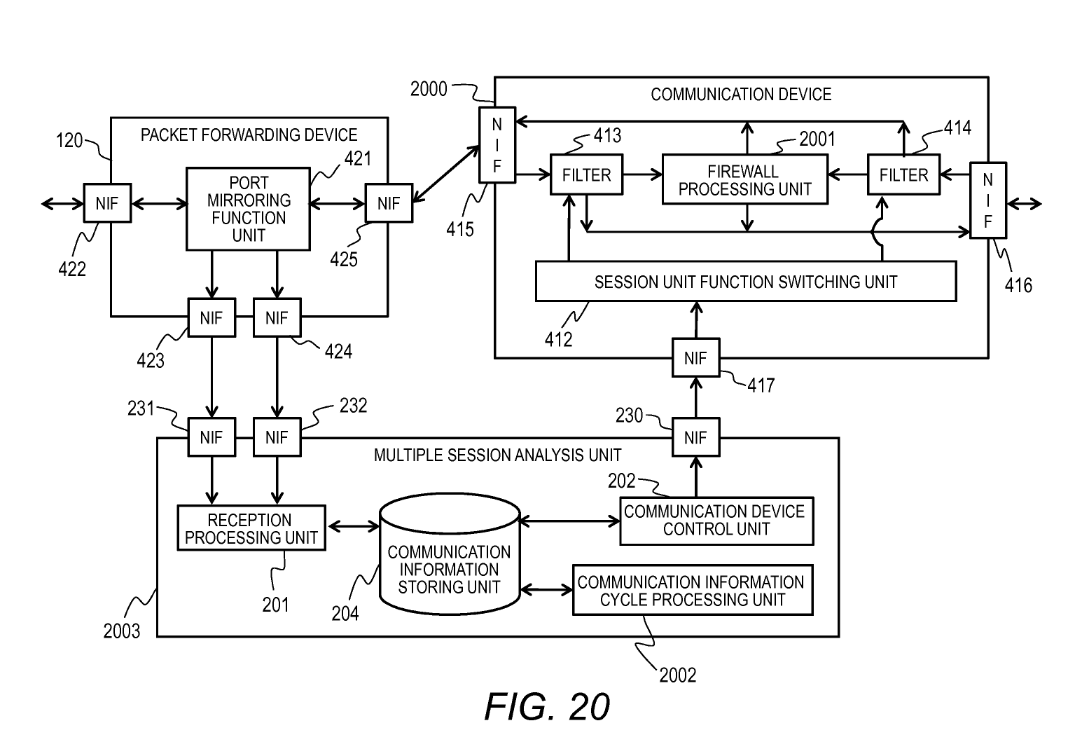

FIG. 20 shows a function block configuration example of a system including a multiple session analysis device 2003, a communication device 2000 controlled by the multiple session analysis device 2003, and a packet forwarding device 120 that transmits mirror packets to the multiple session analysis device 2003.

The multiple session analysis device 2003 includes a reception processing unit 201, a communication device control unit 202, a communication information cycle processing unit 2002, a NIF 230, a NIF 231, a NIF 232, and a communication information storing unit 204. The communication device 2000 includes a firewall processing unit 2001. The firewall processing unit 2001 blocks packets determined to be suspicious according to set standards. A session unit function switching unit 412 inputs packets to the firewall processing unit 201 or bypasses the firewall processing unit 2001 on the basis of a function switching command received from the multiple session analysis device 100.

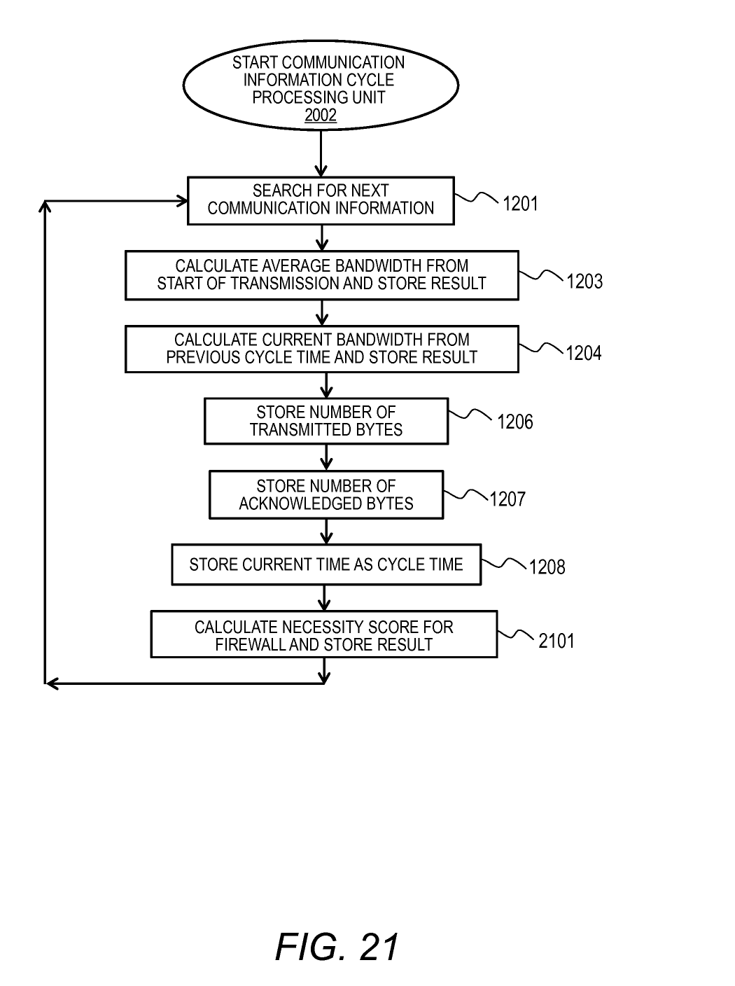

FIG. 21 is a flow chart showing operations of the communication information cycle processing unit 2002. FIG. 21 is a flow chart showing operation details of the communication information cycle processing unit 2002. Unlike the flow chart shown in FIG. 12 of Embodiment 1, step 1202 and step 1209 are omitted, and step 1210 is replaced by step 2101. In step 2101, the communication information cycle processing unit 2002 calculates the necessity score for the firewall function of the communication device 2000 and stores it in score 818 (2101).

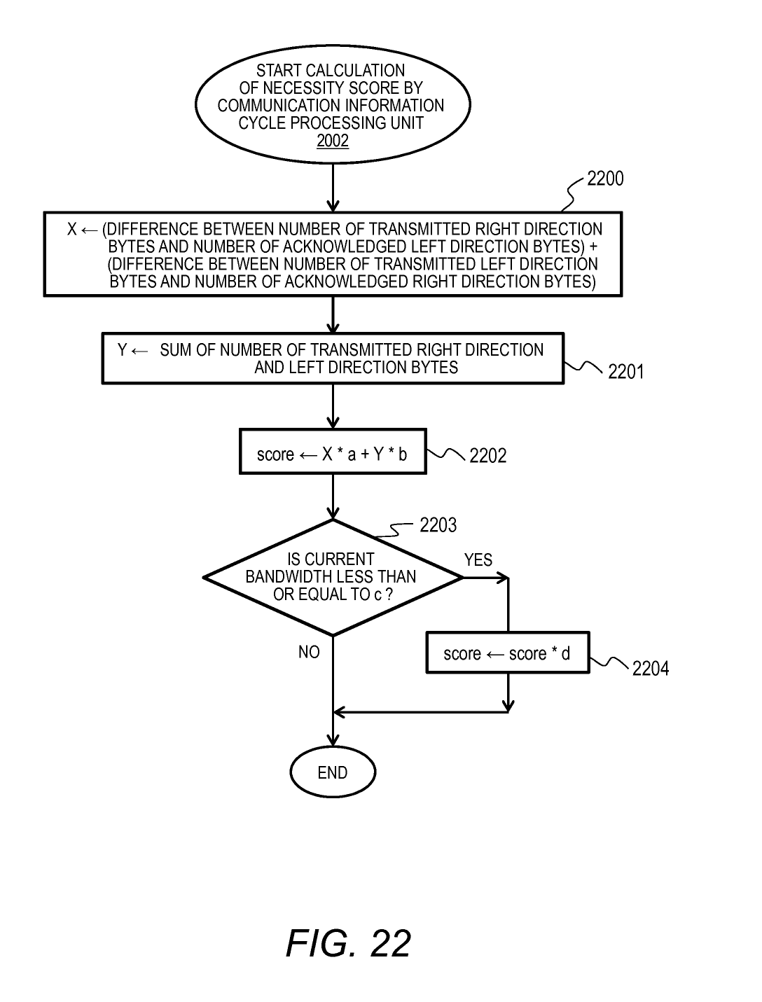

FIG. 22 is a flow chart showing details of an operation (2101) performed by the communication information cycle processing unit 2002 of calculating the necessity score for the firewall function of the communication device 2000.

The communication information cycle processing unit 2002 calculates the absolute value of the difference between the number of transmitted right-direction bytes last_tx_bytes[0] 803 and the number of acknowledged left-direction bytes last_ack_bytes[1] 806. The communication information cycle processing unit 2002 calculates the absolute value of the difference between the number of transmitted left-direction bytes last_tx_bytes[1] 804 and the number of acknowledged right-direction bytes last_ack_bytes[0] 805. The communication information cycle processing unit 2002 defines the sum of the two absolute values as X (2200).

The communication information cycle processing unit 2002 defines the sum of the number of transmitted right-direction bytes last_tx_bytes[0] 803 and the number of acknowledged left-direction bytes last_ack_bytes[0] 804 as Y (2201).

The communication information cycle processing unit 2002 stores X*a+Y*b as score 818 (2202). a and b are modifiable parameters. a can be set to 100 and b can be set to 1, for example.

By the calculation above, it is possible to find suspicious sessions in which packets are transmitted in one direction but not appropriately acknowledged or sessions with large communication volume. It is possible to effectively use a firewall by performing the firewall function on such sessions.

However, if the sum of current_bw[0] and current_bw[1] is c or less (2203), then the communication information cycle processing unit 2002 multiplies score 818 by a positive value d less than or equal to 1 (2204). In this manner, the necessity score for sessions with a low communication volume and a low degree of danger is reduced.

The necessity score of the firewall function may be calculated by a different method. The necessity score may be calculated only using a variable X, for example. The determination of whether or not it is necessary to perform the firewall function based on the necessity score is similar to the necessity determination of Embodiment 1. The communication device control unit 202 may control the firewall function on the basis of the results of the determination of whether or not the firewall function is necessary. The communication device control unit 202 may display in an output device (not shown) for a manager information including determination results without controlling the firewall function or while controlling the firewall function.

### Embodiment 5

In Embodiments 1 to 4, examples were shown in which the multiple session analysis device was controlled by a single communication device. In the present embodiment, an example will be shown in which the multiple session analysis device is controlled by a plurality of communication devices. Unless otherwise noted, configurations similar to those of Embodiments 1 to 3 are assigned the same reference characters and descriptions thereof are omitted.

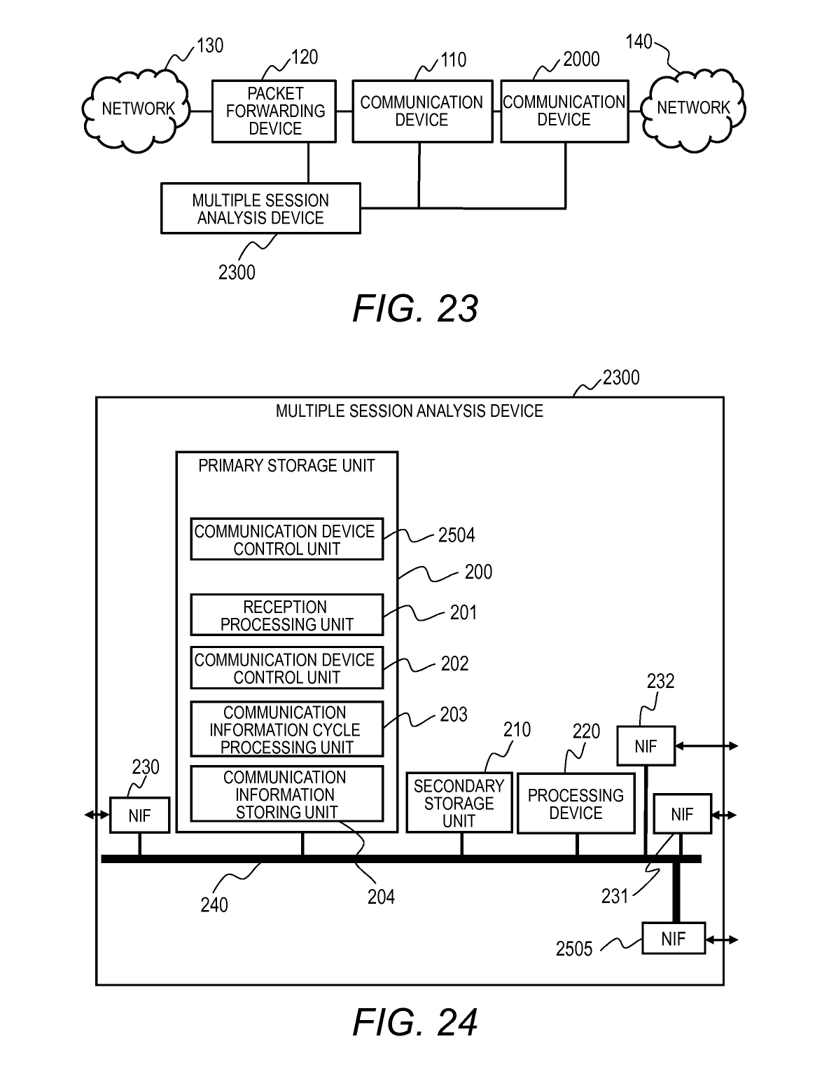

FIG. 23 shows a configuration of a network system including a multiple session analysis device 2300 of the present embodiment. The multiple session analysis device 2300 is connected to a communication device 110, a communication device 2000, and a packet forwarding device 120. The communication device 2000 is connected to a network 140 and the packet forwarding device 120 is connected to a network 130.

FIG. 24 shows a hardware configuration example of the multiple session analysis device 2300 of the present embodiment. The multiple session analysis device 100 includes a primary storage unit 200, a secondary storage unit 210, a processing device 220, a network interface 230 (NIF), a NIF 231, a NIF 232, a NIF 2505, and a system bus 240 that connects all of these to each other and transmits data. The hardware configuration is similar to that of the multiple session analysis device 100.

The primary storage unit 200 of the multiple session analysis device 2300 stores not only a reception processing unit 201, a communication device control unit 202, a communication information cycle processing unit 203, and a communication information storing unit 204, but also a communication device control unit 2504.

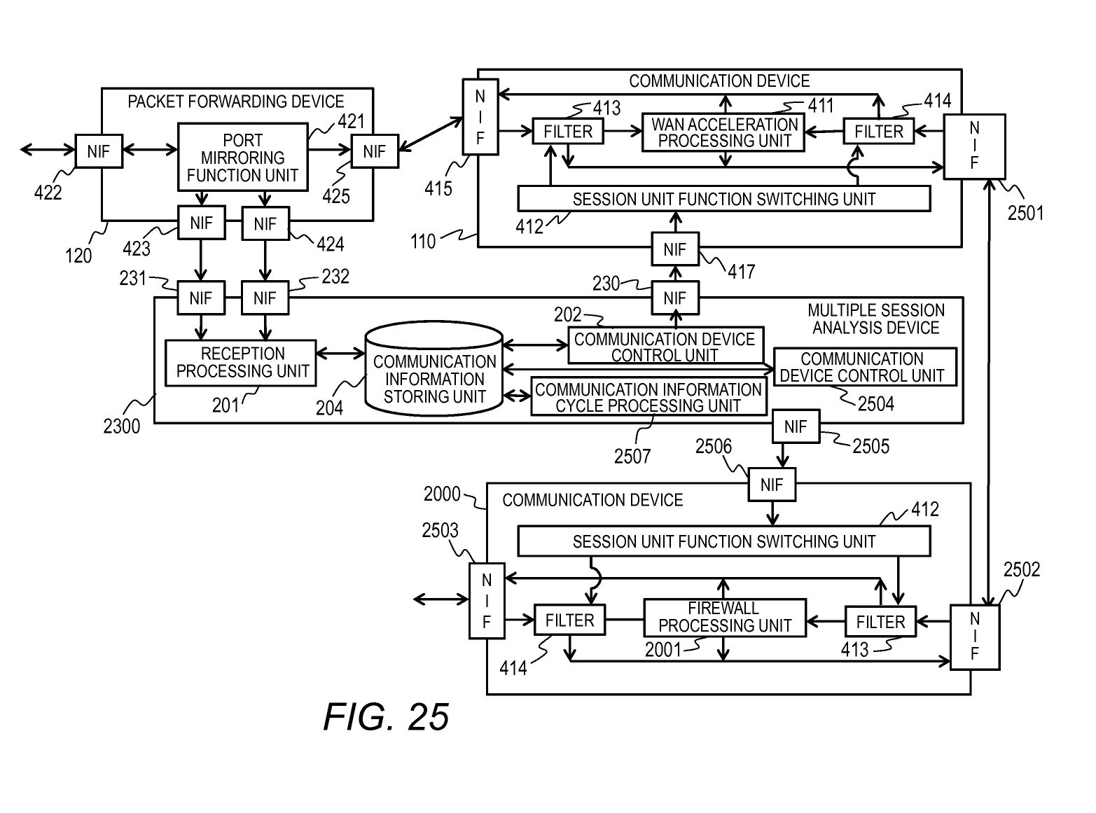

FIG. 25 shows a function block configuration example of a system including a multiple session analysis device 2300, a communication device 110 and a communication device 2000 controlled by the multiple session analysis device 2300, and a packet forwarding device 120 that transmits mirror packets to the multiple session analysis device 100.

The multiple session analysis device 2300 includes a reception processing unit 201, two communication device control units 202 and 2504, a communication information cycle processing unit 2507, communication information storing unit 204, a NIF 230, a NIF 231, a NIF 232, and a NIF 2505. The communication device 110 includes a WAN acceleration processing unit 411, a session unit function switching unit 412, a filter 413, a filter 414, a NIF 415, a NIF 2501, and a NIF 417.

The packet forwarding device 120 includes a port mirroring functional unit 421, a NIF 422, a NIF 423, a NIF 424, and a NIF 425. The communication device 2000 includes a firewall processing unit 2001, a session unit function switching unit 412, a filter 413, a filter 414, a NIF 2502, a NIF 2503, and a NIF 2506.

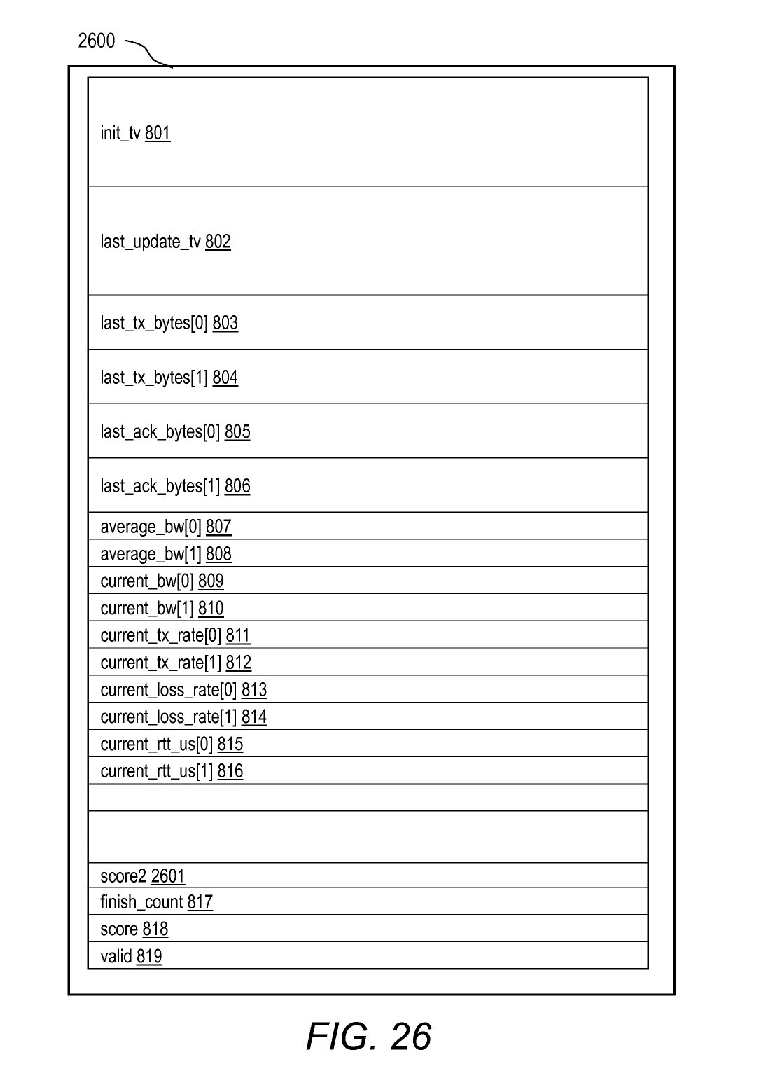

FIG. 26 shows a data structure of an analysis_data structure 2600 of the present embodiment. The analysis_data structure 2600 is session information primarily updated by the communication information cycle processing unit 2507. The analysis_data structure 2600 of the present example has score2 2601 as a value in addition to the data of the analysis_data structure 800 of Embodiment 1.

The communication information cycle processing unit 2507 calculates the necessity score for the WAN acceleration function by the processes (1201-1210) shown in Embodiment 1 and stores it in score 818. Also, the communication information cycle processing unit 2507 calculates the necessity score for the firewall function by the processes shown in Embodiment 4 and stores it in score 2601.

The communication device control unit 202 controls the communication device 110 on the basis of the score 818. The communication device control unit 2504 controls the communication device 2000 on the basis of the score 2601. The determination of whether or not it is necessary to perform the functions based on the necessity score is similar to what was described in Embodiment 1.

According to the present embodiment, it is possible to control a plurality of communication devices using one multiple session analysis device and to reduce the cost of communication devices.

In the present embodiment, an example was described in which two communication devices were controlled, but more communication devices may be controlled by increasing the number of score variables in the analysis_data structure 2600 and the number of communication device control units. Also, if a plurality of coordinated devices are to be controlled, the multiple session analysis device can also control a plurality of communication devices in the same manner using a single score variable and a single communication device control unit.

### Embodiment 6

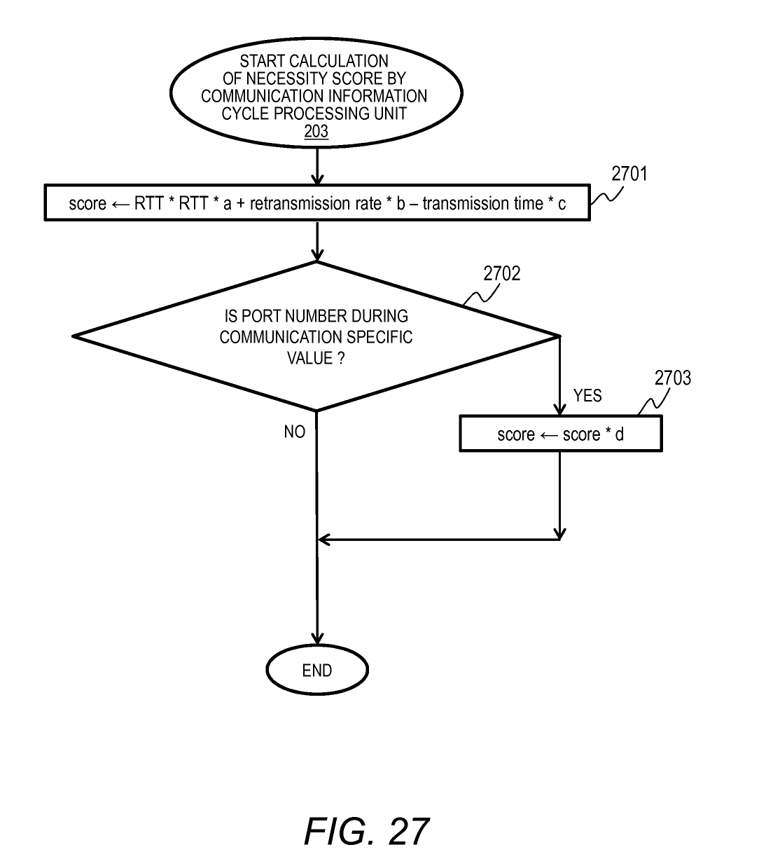

The present embodiment has a similar configuration to that of Embodiment 1 but score 818 in the present embodiment is calculated by a different algorithm. FIG. 27 is a flow chart showing an operation performed by the communication information cycle processing unit 203 of calculating the necessity score for the WAN acceleration function of the communication device 110.

The communication information cycle processing unit 203 calculates the necessity score for left-direction packets. Specifically, the communication information cycle processing unit 203 performs the calculation of (current_rtt_us[0]+current_rtt_us[1])*(current_rtt_us[0]+current_rtt_us[1])*a+current_loss_rate[1] 814*b−(last_update_tv 802−init_tv 801)*c and stores the resulting value in score 818 (2701). a, b, and c are modifiable parameters. a can be set to 0.001, b can be set to 1, and c can be set to 1, for example.

By using such a non-linear method, it is possible to weight variables. In this manner, it is possible to prioritize elements with communication delays. By subtracting score 818 depending on the communication time, or if the communication time is long, it is possible to gradually reduce the priority, and it is possible to prevent only some sessions taking much of the WAN acceleration function of the communication device 110.

Next, if the port number during communication is a specific value (2702:Yes), then score 818*d is stored as score 818 (2703). d is a modifiable parameter. If port 80 is focused on in the communication, for example, then if src_port 603 or dest_port 604 is 80, then score 818*d is stored as score 818 with d being a value of 1 or greater.

In this manner, by calculating the necessity score for only left-direction packets, it is possible to control the priority specifically for left-direction communication, which is effective for cases in which the communication function of the communication device 110 is only in the left-direction. Also, by adjusting the score 818 depending on the port number, it is possible to increase or decrease the priority of communications of specific conditions.

In the present embodiment, an example was shown in which score 818 is adjusted according to only one port number, but may be adjusted for a plurality of port numbers. In the present embodiment, an example was shown in which the score 818 is adjusted according to a specific port number, but by adjusting score 818 according to a specific IP address, it is also possible to increase or decrease the priority of a specific communication destination. Both port number and IP address may be set as conditions.

This invention is not limited to the above-described embodiments but includes various modifications. The above-described embodiments have been described in details for better understanding of this invention and are not limited to the ones including all the configurations described above. A part of the configuration of one embodiment may be replaced with that of another embodiment; the configuration of one embodiment may be incorporated to the configuration of another embodiment. A part of the configuration of each embodiment may be added, deleted, or replaced by that of a different configuration.

The above-described configurations, functions, and processing units, for all or a part of them, may be implemented by hardware: for example, by designing an integrated circuit. The above-described configurations and functions may be implemented by software, which means that a processor interprets and executes programs for performing the functions. The information of programs, tables, and files to implement the functions may be stored in a storage device such as a memory, a hard disk drive, or an SSD (Solid State Drive), or a storage medium such as an IC card, or an SD card.

What is claimed is:

1. An analysis device that analyzes a packet processed by a communication device connected with a network, the analysis device comprising:
a receiver that receives a mirror packet of the packet transmitted through the network; and
an analyzer that obtains and analyzes a portion of information in the mirror packet, and determines a necessity or lack thereof for a function of the communication device to be performed on the packet transmitted through the network based on analysis results.

2. The analysis device according to claim 1, wherein the analyzer analyzes header information of a plurality of packets included respectively in a plurality of communications, and determines the necessity or lack thereof for the function of the communication device to be performed on each of the plurality of communications based on analysis results of the analyzer.

3. The analysis device according to claim 2,
wherein the function is a network acceleration function, and
wherein the analyzer determines a necessity or lack thereof for the network acceleration function to be performed on each of the plurality of communications based on at least one of a communication delay and a packet loss rate in each of the plurality of communications.

4. The analysis device according to claim 3, wherein the analyzer determines a necessity or lack thereof for the network acceleration function to be performed respectively on the plurality of communications based on the communication delay, the packet loss rate, and communication volume in each of the plurality of communications.

5. The analysis device according to claim 2,
wherein said function is a firewall function, and
wherein the analyzer determines a necessity or lack thereof for the firewall function to be performed respectively on the plurality of communications based on a difference of a number of packets in one direction and a number of packets in a direction opposite thereto in each of the plurality of communications.

6. The analysis device according to claim 2, wherein the analyzer determines the necessity or lack thereof for the network acceleration function to be performed respectively on the plurality of communications based on a destination of each of the plurality of communications.

7. The analysis device according to claim 2, wherein each of the plurality of communications is a TCP session in a TCP/IP protocol.

8. The analysis device according to claim 1, further comprising:
a controller that controls performing of the function of the communication device on transmitted packets according to the analysis results of the analyzer.

9. The control device according to claim 8,
wherein the receiver selects header information of the mirror packet and stores the header information in storage,
wherein the analyzer reads the header information from the storage and analyzes the header information, and stores in the storage the analysis results indicating the necessity or lack thereof for performing the function of the communication device, and
wherein the controller reads the analysis results from the storage and controls the function of the communication device according to the analysis results.

10. A system, comprising:
a communication device connected with a network; and
an analysis device that analyzes a packet processed by the communication device,
wherein the analysis device
receives a mirror packet of the packet transmitted through the network, and
obtains and analyzes a portion of information in the mirror packet, and determines a necessity or lack thereof for a function of the communication device to be performed on the packet transmitted through the network based on analysis results.

11. An analysis method that analyzes a packet processed by a communication device connected with a network, the analysis method comprising:
receiving a mirror packet of the packet transmitted through the network, and
obtaining and analyzing a portion of information in the mirror packet, and determining a necessity or lack thereof for a function of the communication device to be performed on the packet transmitted through the network based on analysis results.
